(19) United States
(12) Patent Application Publication
(10) Pub. No.: US 2021/0404133 A1
(43) Pub. Date: Dec. 30, 2021

(54) A METHOD AND A SYSTEM FOR COLLECTING FLOATING OBJECTS ON A SURFACE OF WATER

(71) Applicant: The Ocean Cleanup Technologies B.V., Rotterdam (NL)

(72) Inventors: Boyan Damir SLAT, Rotterdam (NL); Bruno Charles Victor SAINTE-ROSE, Rotterdam (NL); Theotimus Simeon Johannes DE FEIJTER, Rotterdam (NL); Jean-Sébastien VERJUT, Rotterdam (NL); Arjen René TJALLEMA, Rotterdam (NL); Gerrit Jan GRUNDLEHNER, Rotterdam (NL); Lourens Christiaan BOOT, Rotterdam (NL); Allard Pieter VAN HOEKEN, Rotterdam (NL); Robbert SINT JAGO, Rotterdam (NL)

(21) Appl. No.: 16/611,622

(22) PCT Filed: May 9, 2018
(86) PCT No.: PCT/NL2018/050310

§ 371 Date: Nov. 7, 2019

(30) Foreign Application Priority Data
May 10, 2017 (NL) 2018882
Oct. 31, 2017 (NL) 2019839

(51) Int. Cl. E02B 15/08; C02F 1/40

(52) U.S. Cl. CPC E02B 15/0814; C02F 2103/08; C02F 1/40

(57) ABSTRACT

A method and system for collecting objects floating on or suspended near a surface of water. A collecting system is employed comprising a floating barrier. The collecting system is unanchored to or on the seabed such that the collecting system is free to move along the surface of the water. A submerged portion and non-submerged portion is provided connected to the floating barrier, such that a velocity of the floating barrier along the surface of the water differs from a surface velocity of the water at the location of the floating barrier. Collected plastic objects can be recycled. Further, the ocean currents are followed while being able to collect plastic.

### FIELD OF THE INVENTION

The invention relates to a method and system for collecting floating objects on a surface of water by means of a floating barrier formed on the surface of the water. The method further relates to a method for recycling plastic entities which are obtained by collecting plastic floating in the ocean. Further, the method relates to a method for following ocean currents for collecting encountered plastic objects by means of a collecting system.

### BACKGROUND TO THE INVENTION

Ocean pollution has a great impact on marine ecosystems. The environmental impact of garbage ending up in the ocean can be devastating and is still subject to much research. Plastic pollution forms one of the major pollutants of the oceans at the present day. More and more objects and debris tend to end up in coastal and oceanic environments, necessitating the development of methods and/or systems for reducing waste floating on or suspended near a water surface.

The ocean's water is constantly moving as a result of the rotation of the earth, climate, weather, wind patterns, etc. The world's oceans are characterized by a system of large-scale rotating currents, called ‘gyres’. These gyres provide predictable patterns. It is recognized that floating ocean garbage (e.g. waste, plastic pollution) also tends to move through the ocean covering large distances and following the same predictable patterns. Once seaborne, plastics are most likely found circulating in one of five major ocean gyres: two in the Pacific ocean, one in the Indian ocean, and two in the Atlantic ocean. Although ocean garbage patches are vast, they are not solid islands of plastic, instead, they are dispersed and include a turbid mix of plastic. The plastic entities in the ocean garbage patches may have various sizes.

It has been found that forming an artificial coastline, for example by means of a floating structure, the garbage may be passively concentrated as a result of natural flow of ocean water. The floating structure can then function as a kind of filter for the garbage, wherein water and marine life is allowed to pass, but larger floating objects are retained by means of the floating structure. This is beneficial compared to other methods involving the use of nets. Typically, the use of boats (e.g. for towing) requires a lot of transportation energy (fuel). Also the time and costs involved with such operations tend to be high. Also bycatch may form a problem, wherein fish or other marine species are caught unintentionally while trying to catch objects in the ocean.

Solid screens are already employed for catching the floating/suspended garbage, while allowing sea life to pass underneath the barrier with the water current. Such screens can be used to divert the plastic towards a central collection point (e.g. V-shaped or U-shaped structure). The screens are arranged to form a (floating) barrier for the garbage which is moored to the seabed. The orientation of the barriers slowly pushes the garbage, as a result of the water flow, towards a center of the barrier. In this way, the garbage may become more and more concentrated in function of time. The accumulation of the waste/garbage can then be collected more easily since a central collection point is obtained at which the debris can be buffered. After collection, the debris can be shipped and possibly recycled.

Several technologies have been developed for intercepting (plastic) debris from water surfaces. For instance, The Ocean Cleanup (TOC) foundation has developed technologies using floating booms placed substantially perpendicular to the main ocean plastic flow so that the plastic debris can be concentrated to a point where it can be extracted from the water, shipped and processed (e.g. recycling). The TOC array is designed to be as flexible as possible, allowing it to move along with the waves so that the structure is able to survive extreme weather conditions. A TOC array is designed to form an artificial coastline.

There is a need for improving the ability to capture garbage in an effective manner by means of a debris extractor. The efficiency of the garbage collection operation may be defined in different ways, for example captured mass of garbage (e.g. plastic) per unit time, per unit cost, and/or per unit length of the barrier. Other ways are possible for defining a garbage collection efficiency.

### SUMMARY OF THE INVENTION

It is an object of the invention to provide a system and a method that obviates at least one of the above mentioned drawbacks.

It is alternatively, or additionally, an object of the invention to provide a system and a method for effectively collecting objects floating on or suspended near a surface of water.

It is alternatively, or additionally, an object of the invention to provide a system and a method that improves the efficiency of ocean garbage collection.

It is alternatively, or additionally, an object of the invention to provide a system and a method for garbage collection from water, wherein dynamic water conditions are better taken into account.

It is alternatively, or additionally, an object of the invention to reduce the impact of oceanic plastic and provide a strategy for effectively removing ocean marine surface plastic, utilizing floating collection devices and the ocean currents.

Thereto, according to a first aspect, the invention provides for a method for collecting objects floating on or suspended near a surface of water by means of a collecting system comprising a floating barrier, wherein, in use, the collecting system is unanchored to or on the seabed such that the collecting system is free to move along the surface of the water. The method includes providing the floating barrier having a non-submerged portion and a submerged portion, wherein at least the non-submerged portion provides air resistance when subjected to wind, and at least the submerged portion provides drag when the floating barrier is moved along the surface of the water, wherein as a result of the air resistance and the drag a difference is obtained in a velocity of the floating barrier along the surface of the water with respect to a velocity of the objects floating on or suspended near the surface of water at the location of the floating barrier.

The non-submerged portion can enable interaction with wind or resulting water waves for influencing a velocity of the floating barrier. The submerged portion can enable interaction with water current for influencing the velocity of the floating barrier. The orientation of the floating barrier of the collecting system can be changed under influence of external forces, at least including wind, waves, the flow of water, or currents. In this way, the collecting system may adapt better to the dynamic water and/or weather conditions. The collecting system is allowed to follow ocean currents while taking into account the effects of wind for enhancing the collecting efficiency.

The effect of wind on the objects floating on or suspended near the surface of water can be limited. Hence, by allowing the collecting system to move along with the wind at a different speed than the objects, the objects may be collected more efficiently.

Optionally, the collecting system is mainly wind-driven. For this purpose, the collecting system can be configured such that the encountered wind forces are larger than the encountered drag forces when the floating barrier is moved along the surface of the water. In this way, the collecting system can move faster through the water than the objects, which creates the velocity difference between the floating barrier and the objects floating on or suspended near the surface of water at the location of the floating barrier greater, so that more objects can be collected.

As a result of the velocity difference between the objects and the floating barrier, the objects can more easily collected. Rather than connecting or tethering the floating barrier to a bottom of a water mass (e.g. a seabed), the resulting resistance to the movement (cf. drag) of the floating barrier along the surface of the water can be increased.

The to be collected objects floating on or suspended near the surface of the water move along the flow of water. Instead of solely slowing down the collecting system for collecting the objects, for example by means of drag members, the collecting system can be configured to be wind-driven, having a higher air resistance than the objects. Advantageously, the collecting system can have a higher moving speed along the surface of the water as a result of wind, thus effectively moving towards the to be collected objects. Hence, the collecting system, while moving along the flow of water, can effectively move in the direction of the objects for collection, rather than solely being slowed down so the objects moving along the flow of water with a higher speed can move towards it.

The air resistance and drag of the floating barrier differs from the air resistance and drag of the to be collected objects such that the floating structure can, at least partially under the influence of wind, move towards the objects. Wind can cause the collecting system to move along the surface of the water with a higher speed than the to be collected objects. The size and shape of the collecting system may result in a substantially larger aerodynamic resistance compared to the to be collecting objects floating on or suspended near the surface of the water. This will make it easier for the collecting system to be carried along by wind, inducing an effective velocity difference between the collecting system and the to be collected objects, wherein the collecting system moves towards the to be collected objects.

Optionally, the ratio of air resistance and drag for the floating barrier is larger than the ratio of air resistance and drag of the objects to be collected. Hence, the effect of wind is more dominant on the floating barrier than on the objects to be collected. Thus, the speed the floating barrier can reach, due to the balance between air resistance induced wind force and drag induced force, can be higher than the speed the objects to be collected can reach due to the balance between air resistance induced wind force and drag induced force.

Optionally, the floating barrier forms an elongated floating barrier line having a first end and a second end. The drag encountered by the submerged-portion of the floating barrier can be smaller at the first and second end of the floating barrier relative to other, e.g. middle, parts of the floating barrier. Alternatively, or additionally, the air resistance encountered by the non-submerged-portion of the floating barrier can be higher at the first end and second end of the floating barrier relative to other, e.g. middle, parts of the floating barrier. In this way, self-orientation under the influence of external forces induced by at least one of the wind, waves or water current is enabled. The floating barrier may be bent in a curved and/or arc-shaped form, as a result of drag and/or wind. Thus, when the collecting system moves faster through the water than the objects, the curved floating barrier can easily intercept and collect the objects floating on or suspended near the surface of water.

Optionally, a submerged member is provided connected to the floating barrier such that the velocity of the floating barrier along the surface of the water differs from the velocity of the objects floating on or suspended near the surface of the water at the location of the floating barrier. The submerged portion can act as a source of drag in the water, e.g. in a water layer with a lower current speed than the surface current, wherein the encountered drag of the moving collecting system is increased by the resulting drag of the submerged portion moving through water. In an advantageous way, the submerged portion may act as a brake for the movement of the floating barrier along the surface of the water, resulting in a beneficial relative velocity difference of the floating barrier with respect to the surface velocity of the water at the location of the floating barrier. Furthermore, the air resistance provided by the non-submerged portion results in the floating barrier being moved along the surface of the water under the influence of wind.

A downstream barrier can be formed by the floating barrier for intercepting objects/debris floating on or suspended near a surface of water, wherein upstream objects can flow in a collecting region of the floating barrier as a result of a velocity difference between the floating barrier and the objects upstream. Advantageously, the probability of objects/debris to be captured flowing towards the floating barrier can be increased in this way. Alternatively, an upstream barrier can be formed by the floating barrier for intercepting objects/debris floating on or suspended near a surface of water, wherein downstream objects can be caught in a collecting region of the floating barrier as a result of a velocity difference between the floating barrier and the objects downstream. Advantageously, the probability of objects/debris to be captured by the floating barrier can be increased in this way.

The collecting system is allowed to be carried along the (ocean) current(s), e.g. resulting from a gyre. Therefore, the debris being carried along said ocean current(s) can be followed more effectively by the collecting system, improving the efficiency. In this manner, more debris can be collected or captured than by means of an anchored collecting system. Also, the installation costs can be significantly reduced. The complexity can also be reduced, since anchoring or fixing the collecting system to or on the bottom of a water mass is no longer required. Furthermore, the collecting system may be able to survive more extreme weather conditions since the forces involved for keeping the collecting system anchored at a fixed position are no longer exercised.

The relative velocity difference of the floating barrier with respect to the flow velocity of the objects in the surface water at the location of the floating barrier can cause the objects floating on or suspended near the surface of water to move at a different speed than the floating barrier, so that objects will move towards the floating barrier and be retained by the floating barrier. It will be appreciated that objects suspended near the surface of the water will generally move at the speed of the water near the surface. Objects floating on the surface of the water can have a velocity that is determined by the surface velocity of the water, wind velocity and/or waves. It will be appreciated that the non-submerged portion and a submerged portion, provide the air resistance when subjected to wind, and drag when the floating barrier is moved along the surface of the water. The air resistance and drag are deigned such that the floating barrier moves at a different velocity than the objects floating on or suspended near the surface of the water, resulting collecting of the objects. The air resistance and drag can be deigned such that the floating barrier moves at a higher velocity due to wind force than the objects floating on or suspended near the surface of the water.

Typically, the flow velocity of water gradually changes depending on the depth. Since the submerged member can be employed at certain depth(s), the velocity difference of the water at different depth(s) can be exploited so as to obtain a difference in the velocity of the floating barrier along the surface of the water relative to the velocity of the objects floating on or suspended near the surface of the water at the location of the floating barrier. In this way, the relative velocity of the floating barrier moving along the surface of the water with respect to the velocity of the objects floating on or suspended near the surface of the water surrounding it can be changed. At shallow submerging depths, the submerged member can counteract forces on the floating barrier due to wind velocity. Hence, the submerged member can reduce the velocity of the floating barrier along the surface of the water to differ from a velocity of the objects floating on the surface of the water at the location of the floating barrier. At larger submerging depths the submerged member can be used to obtain a difference in the velocity of the floating barrier along the surface of the water relative to the surface velocity of the water at the location of the floating barrier. Hence, the submerged member can reduce the velocity of the floating barrier along the surface of the water to differ from a velocity of the objects suspended near the surface of the water at the location of the floating barrier. Normally then too the velocity of the floating barrier along the surface of the water differs from a velocity of the objects floating on the surface of the water at the location of the floating barrier. However, the collecting system is still allowed to follow the water current since it can be carried along by it. This can provide the advantage that the collecting system follows a path along the water, e.g. along the ocean surface, that at least partially follows the (ocean) current, and optionally the wind and/or waves. The braking effect of the submerged member can also aid in steering the collecting system, by orienting the floating barrier downstream of the submerged member in the direction of the current, wind and waves. It will be appreciated that the objects will follow the same path. Hence, the collecting system can be always positioned optimally for collecting the objects. This also obviates a problem associated with anchored systems which may lose already caught objects when positioned in a fixed direction. Also, the present system is subjected to smaller static loads than an anchored system. Moreover, the present system is capable of collecting objects of smaller particle size, because the velocity difference is lower, causing the downward force of the plastic pieces in front of the barrier to be smaller (i.e. less buoyant plastic will remain captured as well).

The submerged member can form at least a portion of the submerged portion of the floating barrier. Optionally, the submerged member is submerged to a depth of more than 10 meters, for example more than 50 meters, for example more than 250 meters, up to 1000 meters or even more. The submerging depth depends on the type of submerged member. It will be appreciated that since the collecting system behaves dynamically, the submerging depth of the submerged member may vary with water conditions, such as water flow speed, salinity gradient around the submerged member and barrier speed. It will be appreciated that the submerging depth may vary by the, e.g. the end of the, submerged member moving upwards during operation. If a braking force applied to the floating barrier by the submerged member becomes larger, the submerged member may rise. It is noted that often a difference between the velocity of the water at a certain depth and the water velocity at the surface is smaller for smaller depths. Thus, the submerged member moving upwards due to a larger braking force tends to reduce the braking force due to a reduced velocity difference. This phenomenon can be used to advantage for automatically, but passively, controlling the braking force generated by the submerged member. This can also automatically prevent too high braking forces occurring e.g. in high wind, wave, and/or current conditions. Hence, damage to the collecting system may be prevented. Optionally, the submerged member reduces the velocity of the floating barrier to less than 80%, e.g. to less than 50% or about 20% of the surface flow velocity of the water at the location of the floating barrier.

The relative velocity of the floating barrier relative to the objects can be increased or decreased according to the invention, e.g. by means of the non-submerged portion and the submerged portion, and optionally the submerged member. The velocity of the floating barrier can typically be increased by the non-submerged portion. The velocity of the floating barrier will be typically be decreased (i.e. slowed down) by the submerged portion, and/or with the submerged member acting as a brake for the floating barrier. Thus, the garbage patches carried along with water currents can be followed by the collecting system while in the meantime objects floating on or suspended near a surface of water of said garbage patches can be effectively collected by the collecting system. Advantageously, the floating barrier moving along the surface of the water can be sped up or slowed down without using active actuation means or a motor.

A submerged member may also result in an increased stability of the collecting system moving along the surface of the water, for example as a result of (ocean) currents. By increasing the drag encountered by the collecting system moving along the surface of the water, also the stabilization may be improved.

The floating barrier may better follow the objects floating on or suspended near a surface of water as a result of the non-submerged portion taking into account the effects of the wind.

It is noted that even within the gyres there are local areas with a higher plastic concentration, and areas with lower concentrations. Because substantially the same forces act on the floating barrier as on the plastic debris, they will both be pushed to the same areas. In other words, the collecting systems will automatically gravitate to where these high concentration zones are. Thus the average concentration of plastic in the path of the collecting system is higher than if it would be fixed in a fixed location. This is also referred to as the plastic magnet effect.

Optionally, the objects include debris, such as plastic waste. Additionally or alternatively, the objects form patches which can be solid, semi-solid or viscous.

Optionally, the floating barrier forms an elongated floating barrier line having a first end and a second end. The method can include at least one of: reducing the drag encountered by the submerged-portion of the floating barrier at the first and second end of the floating barrier relative to other parts of the floating barrier, and/or increasing the air resistance encountered by the non-submerged-portion of the floating barrier at the first end and second end of the floating barrier relative to other parts of the floating barrier.

In this way, self-orientation under the influence of external forces induced by at least one of the wind, waves or water current is enabled. The collecting efficiency can be improved as both wind and (ocean) currents can be taken into account, influencing movement and orientation of the floating barrier on the water. The drag encountered by the submerged portion of the floating barrier at the first end and the second end of the floating barrier can be effectively reduced. Hence, the relative effect of wind encountered by the first end and the second end of the floating barrier can be increased. Advantageously, the first end and the second end can be more easily movable under the influence of wind forces and/or less subject to drag. The floating barrier may be bent in a curved and/or arc-shaped form, as a result of drag and/or wind.

Optionally, the submerged-portion of the floating barrier has a reduced drag at and/or near the first end and the second end, and/or the submerged-portion of the floating barrier has an increased drag at other parts than the first end and the second end of the floating barrier.

Advantageously, movement of the first end and the second end under influence of the wind forces can be facilitated with respect to other parts of the floating barrier.

Optionally, the velocity difference between the floating barrier of the collecting system and the objects floating on or suspended near the surface of water at the location of the floating barrier is mainly obtained under the influence of wind (and/or waves created by wind). The wind can blow the floating barrier of the collecting system forward through the water, thus moving the floating barrier with respect to the objects floating on or suspended near the surface of water at the location of the floating barrier, so that the objects can more easily be collected. Hence, the floating barrier can move with its open portion, which defines collection region, facing forward in the direction of the relative movement of the floating barrier along the surface of the water. Also, the floating barrier can orient itself in an improved way for example during changing wind conditions.

Optionally, at least one connection line is provided configured for connecting two parts of the elongated floating barrier so as to maintain a curved floating barrier. By means of the connection line it can be at least partially avoided that objects collected by the floating barrier can escape from the collecting system, e.g. by the floating barrier “flipping” from a concave to a convex shape as seen from the location of the collected objects.

Optionally, the floating barrier comprises at least one floater and a screen connected thereto, wherein the screen extends downwards in the water and provides drag when the floating barrier is moved along the surface of the water, and wherein at least a non-submerged portion of the floater of the floating barrier provides air resistance, wherein optionally the drag encountered by the submerged-portion of the floating barrier at and/or near the first and second end of the floating barrier is reduced by reducing a depth of the screen at and/or near the first and second end. The screen depth can allow for precise control of the local drag encountered by the floating barrier. By changing the screen depth along the length of the floating barrier, locations with higher and lower relative drag may be created. This can have significant influence on re-orientation of the floating barrier. The screen is impermeable to objects to be collected. Preferably, the screen is constructed so as to avoid marine life becoming trapped by the screen. Therefore, the screen can be impermeable to water or have a pore or mesh size to avoid entrapment. A lower end of the screen may be weighted to keep the screen substantially vertical.

Optionally, the depth of the screen adjacent the first and second end is gradually reduced towards the first and second end of the floating barrier.

In this way, a more gradual reduction of the drag is achieved towards the first end and the second end. This can be beneficial for stability of the floating barrier.

Optionally, the air resistance at and/or near the first and second end of the floating barrier is increased by arranging wind resistance members at said first and second end. In this way, it is possible to catch more wind at the first and the second end, by means of the wind resistance members.

According to a further aspect, the invention relates to a method for recycling plastic, wherein the plastic is obtained by collecting plastic objects floating on or suspended near a surface of water by means of a collecting system comprising a floating barrier, wherein, in use, the collecting system is unanchored to or on the seabed such that the collecting system is free to move along the surface of the water, the collecting for instance including collecting plastic objects floating on or suspended near a surface of water according to the method as described herein.

The collecting may include providing a submerged member connected to the floating barrier, such that a velocity of the floating barrier along the surface of the water differs from a velocity of the objects floating on or suspended near the surface of the water at the location of the floating barrier, e.g. such that a velocity of the floating barrier along the surface of the water differs from a surface velocity of the water at the location of the floating barrier.

Recycling is one of the most identified practices available to reduce the impact of waste through the reuse of materials. The collected objects/debris may be transported prior to recycling. For example, a transportation vessel may be employed for collecting plastic accumulated in the collecting system. The collected plastic may be transported to a recycling plant. Additionally, the method may include the step of distinguishing the collected debris/garbage into different categories prior to transportation. This step may also be carried out during transportation and/or after transportation prior to recycling. Different categories may include plastic and non-plastic. However plastic may also be sub-divided into sub-categories.

Optionally, an installation or vessel for recycling is provided on site. In this way, additional transportation costs may be avoided.

Optionally, the collected plastic is further used as base material for manufacturing plastic objects. The collected plastic can be used as base material for manufacturing portions of the collecting system, thereby further contributing to the environmental sustaining effect of the collecting system.

Optionally, the method includes using the collected plastic as base material for manufacturing plastic objects, such as portions of the collecting system.

Optionally, the collecting system is unpropelled. In this way, it is not required to actively transport the collecting system for the purpose of collecting objects floating on or suspended near a surface of water. This allows a high energy saving, such that (ocean) waste or debris can be collected in a more efficient way. However, it is envisaged that the collecting system may comprise detachable or temporary transportation means. For example, it may be propelled or navigated to a certain location by means of a transportation vessel, such as a transportation boat. Once installed, it may no longer require an engine and/or motor for enabling active movement along the surface of the water. The collecting system may be placed in (ocean) current(s) such that the movement of the collecting system along the surface of the water is enabled as a result of the entraining forces of said (ocean) current(s).

According to a further aspect, the invention provides for a method for collecting objects floating on or suspended near a surface of water the method including: providing an unanchored collecting system comprising a floating barrier, and allowing the collecting system to follow ocean currents.

The ocean currents may be mainly a result of gyres. By allowing the collecting system to passively follow ocean gyres, a significant amount of objects, such as ocean plastic, can be collected or removed efficiently. Winds may move the collecting system outside the currents of a gyre. However, it is estimated that this rarely happens. The collecting system can be allowed to follow the ocean current for a significant amount of time and/or over a significant distance. The collecting system can e.g. be allowed to follow the ocean current for months or even years. The collecting system can e.g. be allowed to follow the ocean current for hundreds or even thousands of kilometers. The collecting system may be employed for larger than e.g. 0.1, or even 0.25 or even 0.5 of the circulation period of a gyre. Other values are also envisaged. Preferably the collecting system is employed for at least an entire circulation period of the gyre. For example, the Great Pacific garbage patch is a suitable location for collecting (plastic) debris. The collecting system may also be employed at other locations.

Optionally, the collecting system is unpropelled so that the debris may be collected passively, while the collecting system is carried along the currents resulting from the gyre. Advantageously, it is not required that the floating barrier is towed through a body of water for collecting objects/debris so that the energy efficiency can be improved. Optionally, the collecting system is arranged for travelling and/or collecting objects fully passively.

Problems involved with anchoring and positioning can be avoided by means of an unanchored collecting system which is not fixed in place. Also, because the floating barrier is not anchored in a body of water, the risk of mechanical failure of the structural members or joints of the floating barrier, potentially leading to a complete loss of control of the accumulated/collected objects, can be reduced.

According to a further aspect, the invention provides for a collecting system for collecting objects floating on or suspended near a surface of water comprising a floating barrier, arranged for freely moving along the surface of the water, wherein the floating barrier comprises a non-submerged portion and a submerged portion, wherein the non-submerged portion is configured to provide air resistance when subjected to wind, and the submerged portion is configured to provide drag when the floating barrier moves along the surface of the water, wherein as a result of the air resistance and the drag a difference is obtained in a velocity of the floating barrier along the surface of the water with respect to a velocity of the objects floating on or suspended near the surface of water at the location of the floating barrier.

Such a velocity difference allows a more effective collection of debris. The collecting system may be unanchored to or on the bottom of a water mass, e.g. sea or ocean, so that it can freely move along the surface of the water. In this way, the collecting system and hence the floating barrier can be carried away by and follow the winds and currents of the water mass (e.g. ocean). Since also the objects are dragged along with the winds and currents, and are subject to substantially the same forces, the collecting system can effectively follow the path of the objects and in the meanwhile collect objects as a result of the velocity difference between the velocity of the objects (being carried along with the winds and current) at the location of the floating barrier and the velocity of the floating barrier (being carried along with the winds and current at a different velocity). The objects floating on or suspended near the surface of water at the location of the floating barrier may be carried along with the water. As explained above, the objects suspended near the surface of the water can have substantially the same velocity as the velocity of the water at the surface. The objects floating on the water can have a velocity determined by surface velocity of the water, wind and/or waves. The velocity of the floating barrier can be larger than the surface velocity of the water at the location of the floating barrier. Thus, in this case, the objects/debris will move slower relative to the floating barrier. Hence, the objects can be collected by the collecting system, while the collecting system is allowed to follow the winds and water current(s). The collecting system can be arranged to fully rely on winds and the natural ocean/sea currents to catch and concentrate the objects/debris. An external energy source may thus not be required during a debris collection operation. Through a minimal amount of moving parts a fully autonomous collecting system can be achieved, wherein the cost of offshore operations can be significantly reduced.

The collection system may therefore enable a passive cleanup of the oceans fully exploiting the winds and water currents (e.g. as a result of gyres in a ocean).

Optionally, the system includes a submerged member connected to the floating barrier arranged for providing a difference between the velocity of the floating barrier along the surface of the water and a velocity of the objects floating on or suspended near the surface of the water at the location of the floating barrier.

Optionally, the floating barrier forms an elongated floating barrier line with a first and second end, wherein the floating barrier is arranged to ensure a reduced drag encountered by the submerged-portion of the floating barrier at the first and second end, e.g. relative to other parts of the floating barrier, and/or an increased air resistance encountered by the non-submerged-portion of the floating barrier at the first and second end, e.g. relative to other parts of the floating barrier.

Optionally, the floating barrier comprises at least one floater and a screen connected to each other, wherein the screen extends downwards in the water.

Optionally, the submerged member comprises at least one line connected to the floating barrier.

Optionally, the submerged member further includes one or more drag members arranged for increasing the drag of the submerged member.

Optionally, the submerged member includes a sea anchor, drift anchor and/or drogue.

Optionally, in use, the floating barrier forms a V-shaped or U-shaped collecting region in which debris accumulates.

Optionally, one or more bulk heads are bulkheads are installed on the collecting system to prevent sinking when damaged or leaky.

Optionally, the collecting system includes a deterrent device, such as an acoustic deterrent device, for e.g. temporarily chasing away marine life during extraction of the collected objects from the collecting system.

In this way, the debris can be effectively diverted towards a central collection point, so that they may become more concentrated in the collecting region. A line or similar connection member can connect two positions along the length of the floating barrier to maintain the V or U shape. Other shapes are also possible.

Optionally, the floating barrier comprises at least one concave portion defining a collecting region in which debris can accumulate during use. By means of a concave portion the debris can become entrapped. It will be appreciated that the floating barrier can also have a convex shape, e.g. with debris trapping portions at the end. Objects can flow through an open end of the floating barrier into a concave or V-shaped portion forming a collecting region in which objects can accumulate. The shape of the floating barrier may be chosen such as to eliminate or reduce turbulence within the collecting region.

Optionally, the floating barrier forms an elongated floating barrier line. A larger area can be spanned for confining objects/debris by means of such elongated floating barrier line defining a collection region.

Optionally, the elongated floating barrier line has a first end and a second end, wherein the first end forms the first position and the second end forms the second position. The elongated floating barrier line can have a bending flexibility such that, in use, a collecting region is formed between the first end and the second end.

The elongated floating barrier line disposed between the first end and the second end may allow a convex or concave shape, such as a parabolic shape, when deformed as a result of the wind and flowing water at the surface. Since the first and second ends are pushed or pulled by air resistance and/or drag, automatically a (e.g. parabolic, U-shaped or V-shaped) collecting region can be formed in which the objects/debris can be collected. Moreover, such an arrangement allows for automatic maneuverability of the collecting system, wherein the floating barrier being carried along with wind and water current automatically re-orients itself when the direction of the water current, waves and/or wind changes, such that a concave collecting region is formed facing such as to collect the objects. In this way, the objects/debris can be effectively collected as a result of the velocity difference obtained as a result air resistance and drag.

Optionally, the elongated floating barrier line comprises a plurality of sections connected to each other.

The plurality of sections may be pivotally connected to each other to enable a bending flexibility. In this way, a modular array can be obtained comprising multiple sections connected with each other. This approach may improve the scalability of the collecting system. Advantageously, the system can be applied for both small-scale systems for intercepting plastic near land and multi-kilometer installations for cleaning up large garbage patches (for example located in gyres). A plurality of rigid sections can be employed pivotally connected for allowing flexibility. For this purpose, flexible connecting portions may be arranged allowing movement of (rigid) sections with respect to each other. Alternatively, or additionally, the floating barrier includes one or more elements having a bending flexibility. The floating barrier can be formed as a single elongate member having a bending flexibility.

Optionally, the collecting system further comprises a buffer unit including a space for storing objects, such as debris.

The buffer unit may include a ring, a bag, a box, a container or some other storage unit. The buffer unit can be arranged for substantially preventing the objects from escaping the buffer unit of their own motion The buffer unit can include a one-way valve, e.g. using a flap, an over-topping ramp or a maze-like feature. The buffer unit can be mounted to the center and/or ends of the floating barrier. The buffer unit can increase efficiency by reducing the losses of objects after concentration.

Optionally, at least one connection line is provided configured for connecting two parts of the elongated floating barrier so as to maintain a curved floating barrier.

Optionally, the floating barrier comprises at least one floater and a downwardly extending screen connected thereto, wherein at least the screen is configured to provide drag when the floating barrier is moved along the surface of the water, and wherein at least a non-submerged portion of the floater of the floating barrier is configured to provide air resistance, wherein optionally the drag encountered by the submerged-portion of the floating barrier at and/or near the first and second end of the floating barrier is reduced by reducing a depth of the screen at and/or near the first and second end.

The screen can be configured to capture objects floating on or suspended near the surface of water. However, sea life is allowed to pass underneath the floating barrier. The floater may be arranged to hold the screen. The depth of the screen into the water can be chosen such that also objects suspended near the surface of the water can be blocked effectively, in addition to the objects floating on the surface of water. In this way, the objects can be more effectively held or captured by the floating barrier of the collecting system. It will be appreciated that the screen also provides a certain drag to the collecting system. It is possible that the floating barrier is more subject to wind force than the floating objects. In such case the screen can provide drag to the floating barrier to optimize the susceptibility to wind force. The optional submerged member can be submerged deeper into the water than the screen. Preferably the submerged member is submerged to a depth that is at least two times, preferably at least ten times, more preferably at least a hundred times the depth of the screen.

Optionally, the depth of the screen adjacent the first and second end is gradually reduced towards the first and second end of the floating barrier.

Optionally, the floating barrier comprises wind resistance members for increasing the air resistance at the first and second end.

The submerged portion can reduce the speed at which the floating member will drift with the wind. In this way, the effect of (heavy) weather on the collecting system can be reduced.

Optionally, the collecting system comprises steering means arranged for at least steering the floating barrier of the collecting system when moving along the surface of the water as a result of currents. The steering means may also be arranged to change an orientation of the floating barrier. Advantageously, the system can be steered while being entrained by ocean currents such as to move to locations containing more floating and/or suspended garbage. The steering means can for example include thrusters on the floating barrier arranged for altering, e.g. tweaking an orientation of the system. The steering means could also involve actively changing the buoyancy of the drag member (e.g. using a bladder-principle, for instance as submarines use).

Optionally, the collecting system comprises a positioning system for providing geolocation information, for example a Global Positioning System (GPS) or the like, e.g. solar powered. Additionally or alternatively, means may be provided for tele-communication. Hence, the collecting system may communicate its position, e.g. to a base station and/or to nearby vessels. The method can include combining ocean circulation models predicting the location of plastic hotspots with the GPS location of the collecting system. If there is too big of a mismatch, the collecting system can be returned to its optimal location, e.g. by a service vessel or steering of the collecting system itself.

Optionally, the collecting system comprises sensors for determining a quantity of the garbage and/or debris collected.

Optionally, at least one line connected to the floating barrier is employed as the submerged member. A line can act as a source of drag in the water. Typically the size of line (e.g. length, thickness) mainly determines how much water it can displace and how much drag it can provide. Hence, the braking effect is influenced by the size of the line. It is also possible to use more than one line to increase the drag/resistance.

Optionally, the submerged member includes one or more drag members for increasing the drag of the submerged member. In this way, the resistance and hence the braking effect of the submerged member to the floating barrier can be increased. The drag member can be submerged to a depth of more than 10 meters, preferably more than 50 meters, more preferably more than 100 meters, or even more than 500 meters, up to 1000 meters or even more. The drag member can be connected to the floating barrier via a connecting structure such as one or more lines. A drag of the connecting structure can be less than a drag of the drag member. Further, a plurality of drag members may be employed. The plurality of drag members can be for example spread out along a line, e.g. along a line forming a loop with a first end connected to the floating barrier and a second end connected to the floating barrier. This may improve the stability of the floating barrier freely moving along the surface of the water following the water current. Additionally, the velocity of the floating barrier along the surface of the water may differ more from a velocity of the objects at the location of the floating barrier. Such an increased velocity difference may result in a more efficient debris/garbage collection. The debris/garbage entities may be able to move faster into the collection system as a result of the increased relative speed difference between the floating barrier and the objects at the location of the floating barrier or surrounding the floating barrier.

Optionally, a sea anchor, drift anchor or drogue is employed as the submerged member. The submerged member is arranged to provide a resistance under water. The obtained resistance/drag can change the velocity of the floating barrier connected to the submerged member. In this way, the floating barrier, which is floating on the surface of the water, can be slowed down as a result of the resistance. Typically, the water velocity at a certain depth differs from the surface velocity of the water. Often, the surface velocity of the water is higher than the flow of water at a certain depth (e.g. >300 meter). The submerged member may therefore induce a negative velocity (i.e. braking) with respect to the movement of the floating barrier along the surface of the water. In this way, the relative velocity of the floating barrier can be decreased, while the floating barrier retains sufficient velocity for following or being carried along with the (ocean) current(s), winds and waves. As a result, ocean debris can be collected more effectively.

Optionally, the floating barrier further comprises a collecting platform for collecting objects collected in a collecting region of the floating barrier. For instance, in case of a V-shaped or U-shaped floating barrier, the collecting platform may be arranged centrally where the objects tend to accumulate. In this way, the objects can be naturally funneled to the central collecting platform. The collecting platform may be arranged for removing objects from the water into a collecting container of the collecting platform.

The system and method may also be employed for collecting and/or extracting other components distributed on a water surface in an area filled with water. The cleanup system can be designed to capture any type of debris or objects floating on or suspended near a surface of water.

According to an aspect, the invention provides a method for collecting objects floating on or suspended near a surface of water by means of a collecting system comprising a floating barrier. In use, the collecting system is unanchored to or on the seabed such that the collecting system is free to move along the surface of the water. The method includes providing a submerged member connected to the floating barrier, such that a velocity of the floating barrier along the surface of the water differs from a velocity of the objects floating on or suspended near the surface of the water at the location of the floating barrier.

It is noted that even within the gyres there are local areas with a higher plastic concentration, and areas with lower concentrations. Because the same forces act on the floating barrier as on the plastic debris, they may both be pushed to the same areas. In other words, the collecting systems may automatically gravitate to where these high concentration zones are. Thus the average concentration of plastic in the path of the collecting system is higher than if it would be fixed in a fixed location. This is also referred to as the plastic magnet effect.

Optionally, the collecting system is unpropelled. In this way, it is not required to actively transport the collecting system for the purpose of collecting objects floating on or suspended near a surface of water. This allows a high energy saving, such that (ocean) waste or debris can be collected in a more efficient way. However, it is envisaged that the collecting system may comprise detachable or temporary transportation means. For example, it may be propelled or navigated to a certain location by means of a transportation vessel, such as a transportation boat. Once installed, it may no longer require a motor for enabling active movement along the surface of the water. The collecting system may be placed in (ocean) current(s) such that the movement of the collecting system along the surface of the water is enabled as a result of the entraining forces of said (ocean) current(s).

Furthermore, the submerged member can reduce the speed at which the floating member may drift with the wind. In this way, the effect of (heavy) weather on the collecting system can be reduced.

Optionally, the collecting system comprises steering means arranged for at least steering the floating barrier of the collecting system when moving along the surface of the water as a result of currents. The steering means may also be arranged to change an orientation of the floating barrier. Advantageously, the system can be steered while being entrained by ocean currents such as to move to locations containing more floating and/or suspended garbage. The steering means can for example include thrusters on the floating barrier arranged for altering, e.g. tweaking an orientation of the system. The steering means could also involve actively changing the buoyancy of the drag member (e.g. using a bladder-principle, for instance as submarines use). This allows to navigate the collecting system by exploiting not only the difference of speed between different water layers, but also the difference in direction of different water layers.

Optionally, the collecting system comprises a positioning system for providing geolocation information, for example a Global Positioning System (GPS) or the like, e.g. solar powered. Additionally or alternatively, means may be provided for tele-communication. Hence, the collecting system may communicate its position, e.g. to a base station and/or to nearby vessels. The method can include combining ocean circulation models predicting the location of plastic hotspots with the GPS location of the collecting system. If there is too big of a mismatch, the collecting system can be returned to its optimal location, e.g. by a service vessel or steering of the collecting system itself.

Optionally, the collecting system comprises sensors for determining a quantity of the garbage and/or debris collected.

Optionally, at least one line connected to the floating barrier is employed as the submerged member. A line can act as a source of drag in the water. Typically the size of line (e.g. length, thickness) mainly determines how much water it can displace and how much drag it can provide. Hence, the braking effect is influenced by the size of the line.

It is also possible to use more than one line to increase the drag/resistance.

Optionally, the submerged member includes one or more drag members for increasing the drag of the submerged member. In this way, the resistance and hence the braking effect of the submerged member to the floating barrier can be increased. The drag member can be submerged to a depth of more than 10 meters, preferably more than 50 meters, more preferably more than 100 meters, or even more than 500 meters, up to 1000 meters or even more. The drag member can be connected to the floating barrier via a connecting structure such as one or more lines. A drag of the connecting structure can be less than a drag of the drag member. Further, a plurality of drag members may be employed. The plurality of drag members can be for example spread out along a line, e.g. along a line forming a loop with a first end connected to the floating barrier and a second end connected to the floating barrier. This may improve the stability of the floating barrier freely moving along the surface of the water following the water current. Additionally, the velocity of the floating barrier along the surface of the water may differ more from a velocity of the objects at the location of the floating barrier. Such an increased velocity difference may result in a more efficient debris/garbage collection. The debris/garbage entities may be able to move faster into the collection system as a result of the increased relative speed difference between the floating barrier and the objects at the location of the floating barrier or surrounding the floating barrier.

Optionally, a sea anchor, drift anchor or drogue is employed as the submerged member. The submerged member is arranged to provide a resistance under water. The obtained resistance/drag can change the velocity of the floating barrier connected to the submerged member. In this way, the floating barrier, which is floating on the surface of the water, can be slowed down as a result of the resistance. Typically, the water velocity at a certain depth differs from the surface velocity of the water. Often, the surface velocity of the water is higher than the flow of water at a certain depth (e.g. >300 meter). The submerged member may therefore induce a negative velocity (i.e. braking) with respect to the movement of the floating barrier along the surface of the water. In this way, the relative velocity of the floating barrier can be decreased, while the floating barrier retains sufficient velocity for following or being carried along with the (ocean) current(s), and optionally wind and waves. As a result, ocean debris can be collected more effectively.

The collecting system is allowed to be carried along the (ocean) current(s), e.g. resulting from a gyre. Therefore, the debris being carried along said ocean current(s) can be followed more effectively by the collecting system, improving the efficiency. In this manner, more debris can be collected or captured than by means of an anchored collecting system. Also, the installation costs can be significantly reduced. The complexity can also be reduced, since anchoring or fixing the collecting system to or on the bottom of a water mass is no longer required. Furthermore, the collecting system may be able to survive more extreme weather conditions since the forces involved for keeping the collecting system anchored at a fixed position are no longer exercised.

Optionally, the objects include debris, such as plastic waste, or objects in the form of patches. The objects and/or patches can e.g. be solid, semi-solid or viscous.

Advantageously, the floating barrier moving along the surface of the water can be slowed down without using active actuation means or a motor.

A downstream barrier can be formed by the floating barrier for intercepting objects/debris floating on or suspended near a surface of water, wherein upstream objects can flow in a collecting region of the floating barrier as a result of a velocity difference between the floating barrier and the objects upstream. Advantageously, the probability of objects/debris to be captured flowing towards the floating barrier can be increased in this way.

Alternatively, an upstream barrier can be formed by the floating barrier for intercepting objects/debris floating on or suspended near a surface of water, wherein downstream objects can be caught in a collecting region of the floating barrier as a result of a velocity difference between the floating barrier and the objects downstream. Advantageously, the probability of objects/debris to be captured by the floating barrier can be increased in this way.

According to an aspect, is provided a method for collecting objects floating on or suspended near a surface of water by means of a collecting system comprising a floating barrier. In use, the collecting system is mono-anchored, i.e. it is anchored to one location at a seabed or bottom such that the collecting system is free to re-orient itself on the surface of the water. Advantageously, the collecting system can automatically change its orientation substantially perpendicular to the current, improving capturing said objects. In this way a beneficial automatic re-alignment can be obtained. For instance, the floating barrier may be connected with one line to an anchor point on a bottom or seabed. Alternatively, for example, the floating barrier may have two ends each connected to a line further being connected to a single anchor point on the bottom or seabed. The two lines connected to the two ends may be directly or indirectly connected to the anchor point. For example, in case of an indirect connection, the two lines may meet at a point connected to the anchor point on the bottom or seabed by means of another single line. Many variants are possible for obtaining a mono-anchored collecting system comprising a single anchor point at the bottom or seabed.

According to a further aspect, is provided a collecting system for collecting objects floating on or suspended near a surface of water comprising a floating barrier. The floating barrier is arranged for freely moving along the surface of the water. The system further includes a submerged member connected to the floating barrier arranged for providing a difference between the velocity of the floating barrier along the surface of the water and a velocity of the objects floating on or suspended near the surface of the water at the location of the floating barrier, e.g. a difference between the velocity of the floating barrier along the surface of the water and a surface velocity of the water at the location of the floating barrier.

Optionally, the floating barrier comprises at least one floater and a screen connected to each other, wherein the screen extends downwards in the water. The screen is arranged to capture objects floating on or suspended near the surface of water. However, sea life is allowed to pass underneath the floating barrier. The floater may be arranged to hold the screen. The depth of the screen into the water can be chosen such that also objects suspended near the surface of the water can be blocked effectively, in addition to the objects floating on the surface of water. In this way, the objects can be more effectively held or captured by the floating barrier of the collecting system. It will be appreciated that the screen also provides a certain drag to the collecting system. It is possible that the floating barrier is more subject to wind force than the floating objects. In such case the screen can provide drag to the floating barrier to reduce the susceptibility to wind force. Preferably the submerged member is submerged deeper into the water than the screen. Preferably the submerged member is submerged to a depth that is at least two times, preferably at least ten times, more preferably at least a hundred times the depth of the screen.

Optionally, the submerged member is connected to the floating barrier at a first attachment position and at a second attachment position, the first and second attachment positions being spaced apart along the floating barrier.

The elongated floating barrier line disposed between the first end and the second attachment positions may allow a parabolic shape when deformed as a result of the flowing water at the surface (fluid-structure interaction), since the first attachment position and the second attachment position are connected with the submerged member providing additional resistance to the movement of the floating barrier moving along on the surface of the water. Since the first and second attachment positions are pulled in a direction different from the direction of the flowing water at the surface, automatically a (e.g. parabolic, U-shaped or V-shaped) collecting region can be formed in which the objects/debris can be collected. Moreover, such an arrangement allows for automatic maneuverability of the collecting system, wherein the floating barrier being carried along with a water current automatically re-orients itself when the direction of the water current, waves and/or wind changes, such that a concave collecting region is formed facing an upstream direction of the flow. In this way, the objects/debris can be effectively collected downstream as a result of the velocity difference obtained as a result of the additional resistance provided by the submerged member connected to the first end and the second end of the elongated floating barrier line.

It will be appreciated that any of the aspects, features and options described in view of the method apply equally to the described collecting system. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic diagram of an embodiment of a collecting system;

FIG. 2 shows a schematic diagram of an embodiment of a collecting system;

FIG. 3 shows a schematic diagram of an embodiment of a collecting system;

FIG. 4 shows a schematic diagram of an embodiment of a collecting system;

FIG. 5 shows a schematic diagram of an embodiment of a collecting system;

FIG. 6 shows a schematic diagram of an embodiment of a collecting system;

FIG. 7 shows a schematic diagram of an embodiment of a collecting system;

FIG. 8 shows an embodiment of a part of a floating barrier;

FIG. 9 shows an embodiment of a part of a floating barrier;

FIG. 10 shows a schematic diagram of a method for collecting objects on or near a surface of water;

FIG. 11 shows a schematic diagram of a method for collecting objects on or near a surface of water; and

FIG. 12 shows a schematic diagram of an embodiment of a collecting system;

FIG. 13 shows a schematic diagram of an embodiment of a collecting system;

FIG. 14 shows a schematic diagram of an embodiment of a collecting system;

FIG. 15 shows a schematic diagram of an embodiment of a floating barrier holding portion;

FIG. 16 shows a schematic diagram of an embodiment of a collecting system;

FIG. 17 shows a schematic diagram of an embodiment of a collecting system;

FIG. 18 shows an embodiment of a drag member of a submerged member; and

FIG. 19 shows an embodiment of drag members of a submerged member.

### DETAILED DESCRIPTION

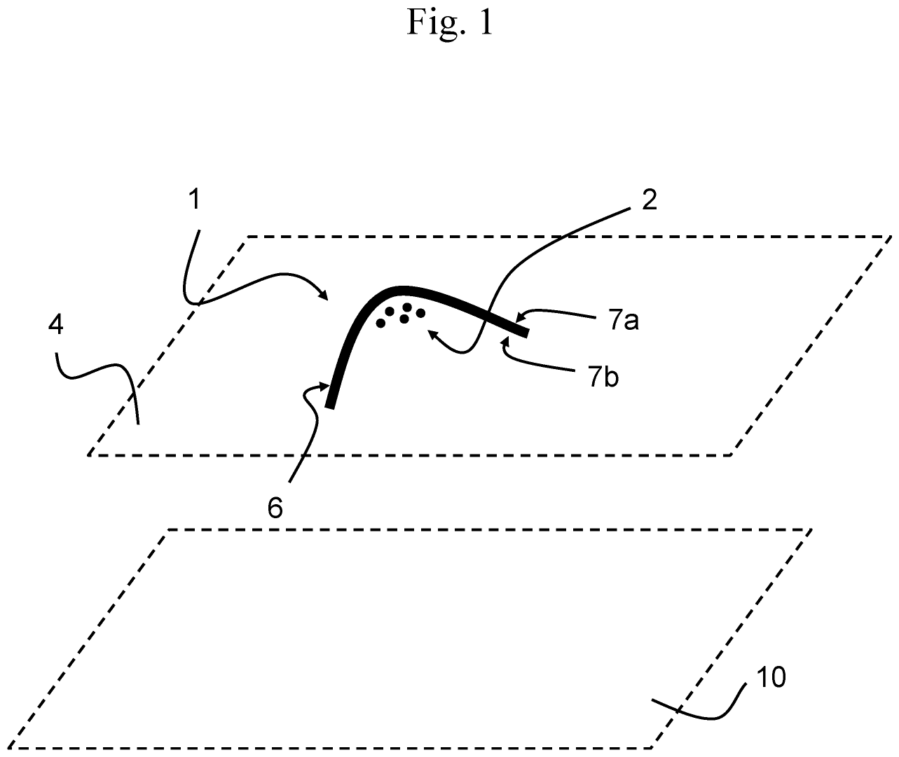

FIG. 1 shows a schematic diagram of an embodiment of a collecting system 1 for collecting objects 2 floating on or suspended near a surface of water 4. The collecting system 1 comprises a floating barrier 6, wherein, in use, the collecting system 1 is unanchored to or on the seabed 10 such that the collecting system 1 is free to move along the surface of the water 4. The floating barrier 6 has a non-submerged portion 7a and a submerged portion 7b, wherein at least the non-submerged portion 7a provides air resistance when subjected to wind, and at least the submerged portion 7b provides drag from the water when the floating barrier is moved along the surface of the water 4, wherein as a result of the air resistance and the drag a difference is obtained in a velocity of the floating barrier 6 along the surface of the water 4 with respect to a velocity of the objects 2 floating on or suspended near the surface of water at the location of the floating barrier. Hence, the effect of wind and water on the velocity of the floating barrier 1 differs from the effect of wind and water on the velocity of the objects 2. The collecting system 1 can be driven by wind, waves and/or currents, for example lacking an active propulsion means such as a motor.

The air resistance and drag can cause the collecting system to move faster through the water than the objects. Both the collecting system and the to be collected objects can be carried along the water current. When the collecting system is arranged to catch more wind than the to be collected objects, the collecting system can move with a higher speed along the water surface, under the influence of wind. The obtained speed difference obtained between the collecting system and the to be collected floating objects can ensure that these floating objects are collected in a more efficient manner by the floating barrier. The to be collected objects can for instance be substantially made out of plastic, such as but not limited to pieces of plastic, plastic foils, plastic bottles, plastic nets, plastic parts, etc.

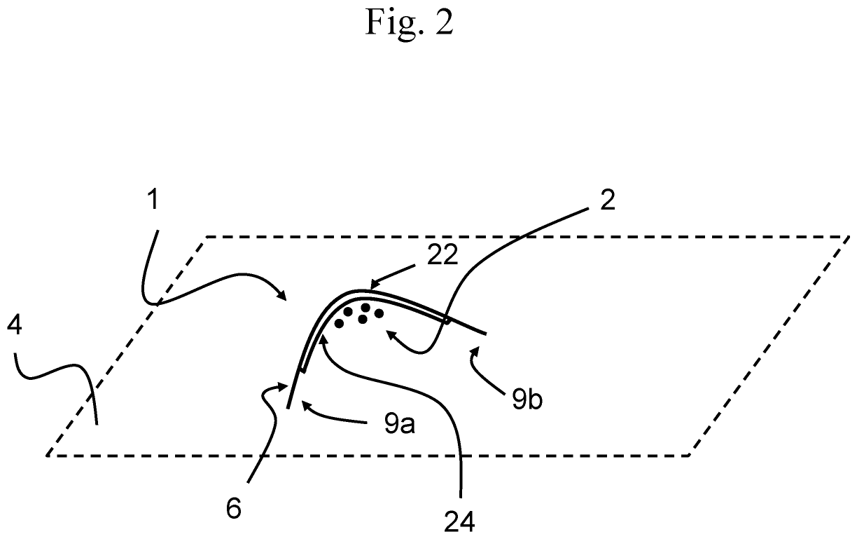

FIG. 2 shows a schematic diagram of an embodiment of a collecting system 1. Advantageously, in this embodiment, the floating barrier 6 forms an elongated floating barrier line having a first end 9a and a second end 9b. The floating barrier 6 is configured such that the drag encountered by the submerged-portion of the floating barrier at and near the first 9a and second end 9b of the floating barrier 6 relative to other parts of the floating barrier 6 is reduced. Additionally or alternatively, the air resistance encountered by the non-submerged-portion of the floating barrier 6 at and/or near the first end 9a and second end 9b of the floating barrier relative to other parts of the floating barrier 6 can be increased (not shown).

Advantageously, the collecting system 1 can become more wind-driven than current-driven. However, the collecting system 1 can still follow ocean gyres under the influence of ocean currents.

In the shown embodiment of FIG. 2, the floating barrier comprises at least one floater 22 and a screen 24 connected thereto, wherein the screen 24 extends downwards in the water and provides drag when the floating barrier 6 is moved along the surface of the water 4, and wherein at least a non-submerged portion of the floater 22 of the floating barrier 6 provides air resistance. The drag encountered by the submerged-portion of the floating barrier 6 at and near the first and second end 9a, 9b of the floating barrier 6 is reduced by reducing a depth of the screen at and near the first and second end 9a, 9b.

The collecting efficiency can be improved as both wind and (ocean) currents are taken into account, influencing movement and orientation of the floating barrier on the water. In this way, the drag encountered by the submerged portion of the floating barrier at and near the first end 9a and the second end 9b of the floating barrier 6 can be effectively reduced. The first end and the second end 9a, 9b can be more easily re-orientated relative to other parts of the floating barrier 6, under the influence of wind forces as they are less subject to drag.

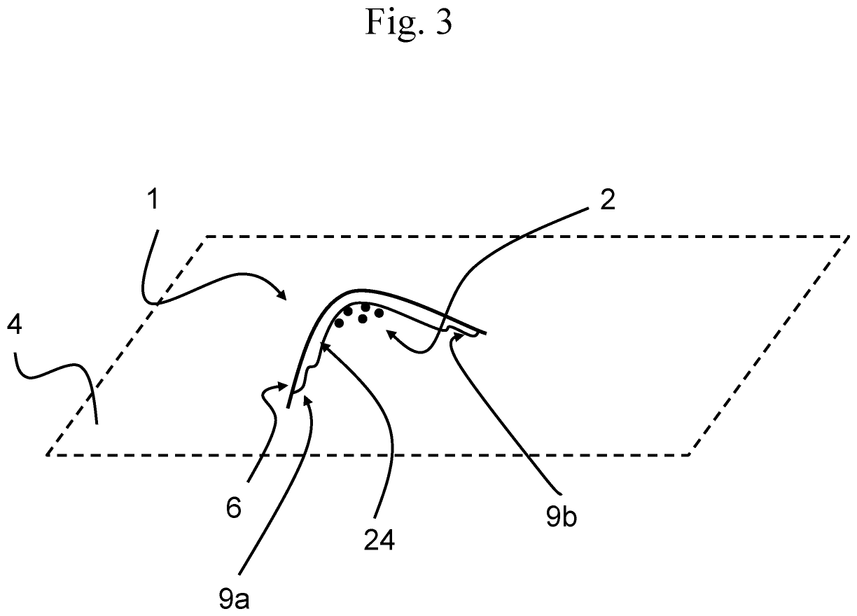

FIG. 3 shows a schematic diagram of an embodiment of a collecting system 1. The floating barrier 6 has a screen 24 having a smaller depth towards the first end 9a and the second end 9b. In this way, a more gradual relative difference in encountered drag can be obtained over the length of the floating barrier 6. Between the first end 9a and the second end 9b, a part has a larger overall depth. It is appreciated that other relative screen depths can be employed. For instance, in a middle portion between the first end 9a and the second end 9b, optionally a reduced screen depth may be employed. This may increase the ‘flexibility’ of the floating barrier 6 to movements when floating on water.

In this example, the wind can exert a substantially equal load on the floating barrier of the collecting system. Further, the screen 22 provides drag under water due to relative motion between the collecting system 1 and the water. By reducing the screen depth at and near the ends 9a, 9b of the floating barrier 6, the drag encountered at those portions of the floating barrier 6 can be reduced. In this way, the first end and the second end 9a, 9b may more easily follow the wind, leading the floating barrier towards objects. Also the orientation stability of the floating barrier can be improved in this way. The floating barrier 6 of the collecting system 1 can orient itself on the basis of wind. Further, the wind is used for driving the floating barrier 6 towards objects 2 for collecting said objects 2. In an example, the screen has a first depth over a larger portion of the total length of the floating barrier 6, wherein near the first and second ends 9a, 9b one or more sections are provided with a screen with reduced second depths. At those one more sections, also a gradual change of the depth may be achieved. The second depth may be a fraction of the first depth, for instance ½, ⅓, ¼, ⅕, ⅙, etc. One or more gradual transitions can be provided in which the screen depth is gradually changed. It is also possible to omit the screen at the first and second end, or at a section near the first end and the second end, i.e. second depth equal to substantially zero. For example, the first depth is 4 meter and the second depth is 2 meter (½). Other, dimensions are also possible. For instance, the first depth may be more than 0.5 meter, more than 2 meter, more than 5 meter, etc. In an example, a plurality of sections are provided having a different screen depths. For example, one or more sections may be provided in which the screen depth is varied gradually. Preferably, the first depth is around 3.5-4.5 meters and the second depth around 1.5-2.5 meters. Other combinations are also possible.

Also the floating barrier 6 can have various lengths. For example the length of the floating barrier 6 may be larger than 300 m, larger than 500 meter. Preferably, the length of the floating barrier is between 600 and 900 meters. The floating barrier can e.g. be tubular, e.g. having a diameter of about 1-2 m, e.g. 1.2 m.

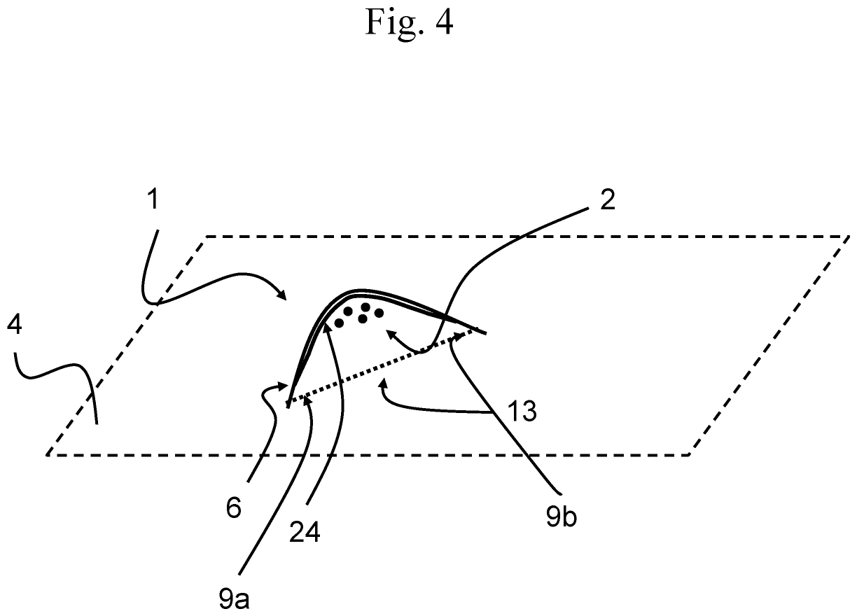

FIG. 4 shows a schematic diagram of an embodiment of a collecting system 1 comprising a connection line 13 configured for connecting two parts of the elongated floating barrier 6 so as to maintain a curved floating barrier 6. In the shown embodiment, the first end 9a and the second end 9b are connected with respect to each other by means of the connection line 13. Also in this embodiment, the floating barrier has a variable screen depth along its length, more particularly, the screen depth is gradually reduced towards the first end 9a and the second end 9b of the floating barrier 6.

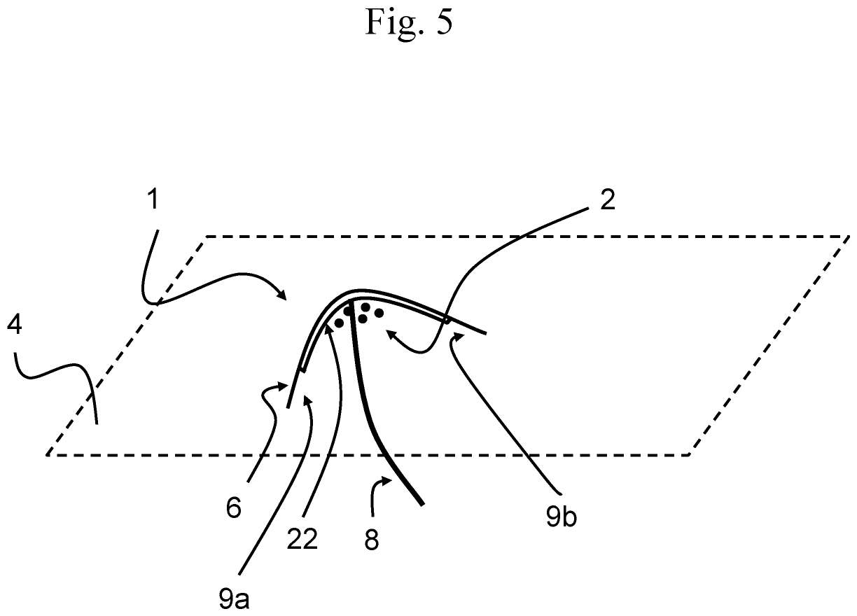

FIG. 5 shows a schematic diagram of an embodiment of a collecting system 1 comprising a submerged member 8 connected to the floating barrier 6 such that the velocity of the floating barrier 6 along the surface of the water 4 differs from the velocity of the objects 2 floating on or suspended near the surface of the water 4 at the location of the floating barrier 6. The submerged member 8 comprises a line extending in the water. One or more drag members can be attached to the submerged member 8 for increasing the drag. Since, the submerged member 8 is connected to a central portion of the floating member 6 between the first end 9a and the second end 9b, the central portion can encounter more drag relative to the first end 9a and the second end 9b. Furthermore, in the shown embodiment, the first end 9a and the second end 9b are free of a screen 24 extending in the water. The floater 22 of the floating barrier 6 may provide a sufficient barrier substantially preventing collected objects 2 from escaping the collecting system 1.

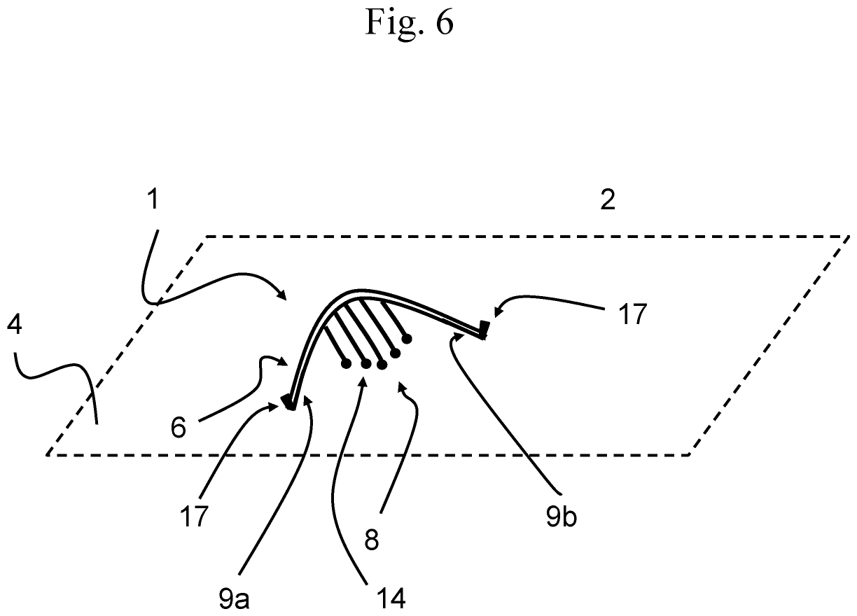

FIG. 6 shows a schematic diagram of an embodiment of a collecting system 1. In this example, the floating barrier 6 comprises a screen with a substantially constant depth along its length. A plurality of submerged members 8 are arranged for locally increasing the drag encountered by the floating barrier 6. A drag member 14 is connected to each submerged member 8 for increasing the encountered drag. It is also possible that a drag member 14 is only connected to some or none of the one or more submerged members 8 connected to the floating barrier 6. The submerged members 8 are arranged between the first end 9a and the second end 9b, such that the drag encountered by the first end 9a and the second end 9b is lower with respect to the other parts of the floating barrier 6.

Additionally, or alternatively, the air resistance at the first and second end 9a, 9b of the floating barrier 6 is increased by arranging wind resistance members 17 at said first and second end 9a, 9b. In this way, more wind can be captured by the floating barrier at the first end and the second end 9a, 9b. Hence, in this embodiment, the air resistance encountered by the non-submerged-portion of the floating barrier 6 at the first end 9a and second end 9b of the floating barrier relative to other parts of the floating barrier 6 is effectively increased. Additionally or alternatively, the screen 24 may be made deeper for locally increasing the drag encountered by the floating barrier moving along the surface of the water.

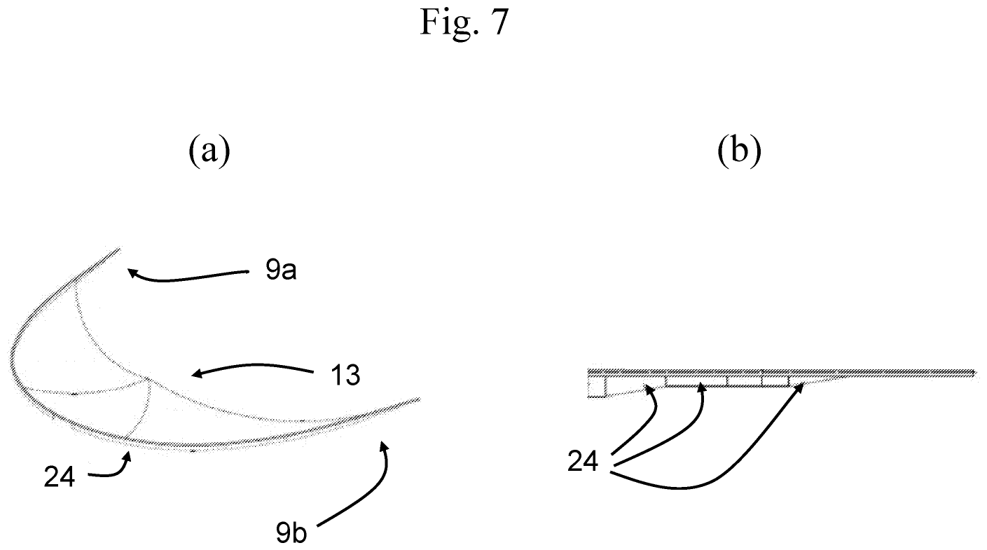

FIG. 7 shows a schematic diagram of an embodiment of a collecting system 1 comprising a plurality of connection lines 13 configured for connecting parts of the elongated floating barrier 6 so as to maintain a curved floating barrier 6. In this example, the depth of the screen 24 of the floating barrier is stepwise reduced towards the first end 9a and the second end 9b. In this example, at a center portion of the floating barrier, between the first end 9a and the second end 9b, an optional reduction in screen depth is present for positioning of a buffer unit (not shown).

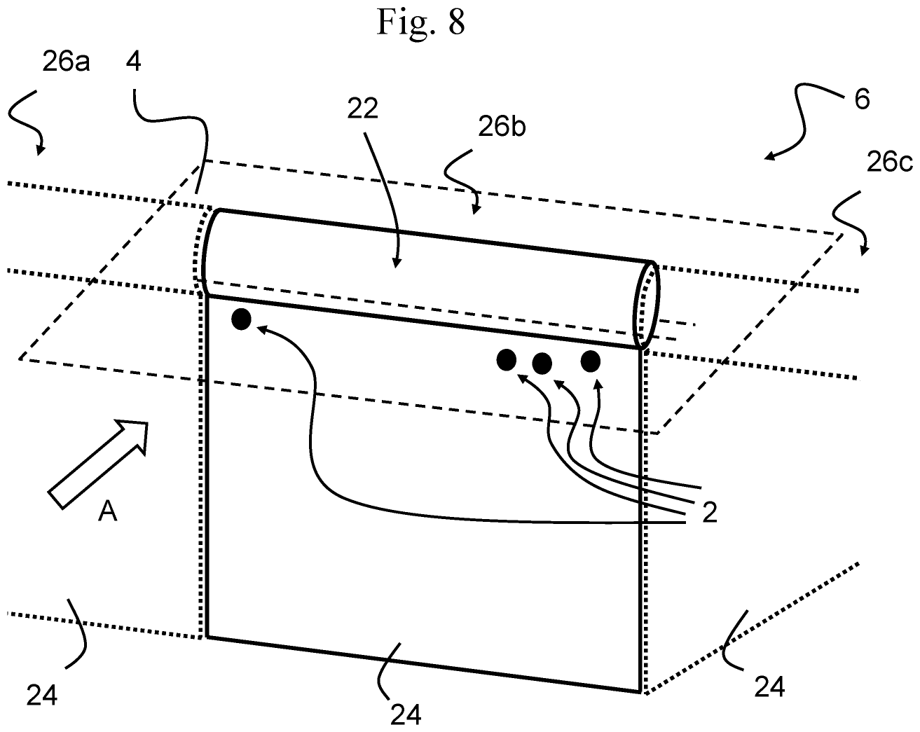

FIG. 8 shows an embodiment of a part of a floating barrier 6. The floating barrier 6 comprises at least one floater 22 and a screen 24 which are connected to each other. The screen 24 of the floating barrier extends downwards in the water. The floater 22 floats on the surface 4 of the water and may be partially submerged in the water. The floater 22 is arranged to maintain buoyancy of the floating barrier. Water at the surface 4 and objects 2 floating on or suspended near the surface 4 of the water may move in a flow direction A and encounter the floating barrier 6. Water and/or sea life are allowed to pass underneath the screen 24. However, the objects 2 are blocked by the floater 22 and/or the screen 24 and can accumulate. The floater 22 may have an empty inner section and/or include materials with a low density for increasing the buoyancy.

By means of the screen 24 underflow caused by currents or waves carrying objects/debris outside the collecting region 16 can be avoided or reduced. By means of the floater 22, splash-over caused by waves carrying objects/debris over the floating barrier and outside the collection region 16 can be avoided or reduced. In the example of FIG. 8, a lower end of the screen 24 is weighted to keep the screen substantially vertical. Thereto a ballast 25 may be included by the screen, e.g. a ballast chain attached along a lower edge of the screen 24.

The optional submerged member 8 can be attached to the floater 22. Alternatively, or additionally, the submerged member 8 can be attached to the screen 24, e.g. to a lower edge of the screen.

An elongated floating barrier line 6 may be formed by means of a plurality of sections 26a, 26b, 26c pivotally connected to each other to enable a bending flexibility. The pivots have sufficient stiffness to prevent folding of the elongate floating barrier line due to pulling forces by the submerged member. The sections 26a, 26b, 26c may be substantially rigid, wherein a flexible connection portion between the multiple sections is provided so as to avoid debris or objects 2 from escaping the flexible barrier 6 while allowing relative movement between the sections 26a, 26b, 26c. Alternatively, or additionally, the sections 26a, 26b, 26c can be substantially rigidly coupled, e.g. welded. Then the sections 26a, 26b, 26c can having a bending flexibility, and yet sufficient stiffness to prevent folding.

The floater 22 may have different cross sectional shapes, such as circular, oval, triangular, square. Other more complex shapes are possible.

As can be seen in the embodiment shown in FIG. 8, the depth of the screen 24 is varied along the length of the floating barrier 6. By changing the depth of the screen 24, the drag encountered by the floating barrier along its length can be changed. Hence, the drag encountered by the first end 9a and the second end 9b relative to other parts of the floating barrier can be reduced.

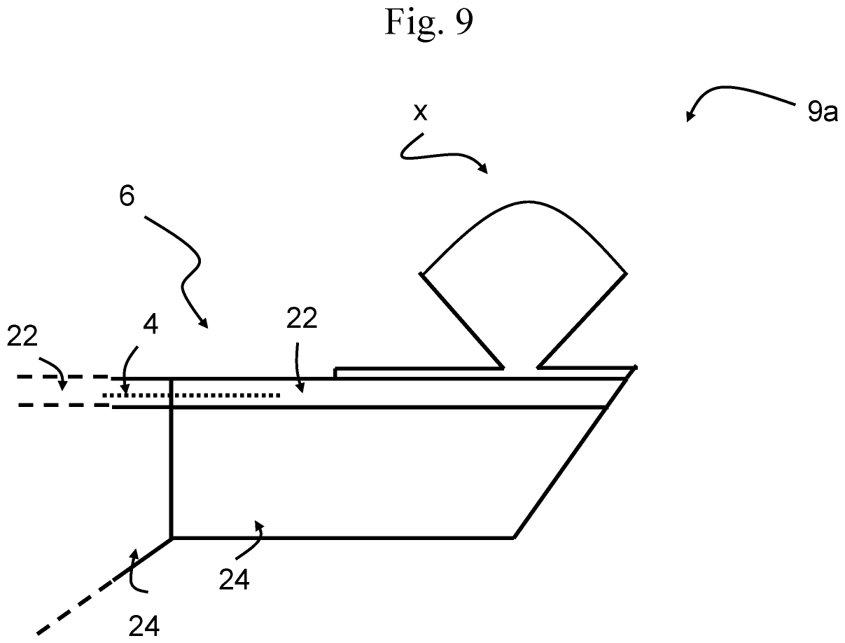

FIG. 9 shows an embodiment of a part of a floating barrier 6 comprising a floater 22 and a screen 24 with a variable screen depth along at least a portion of its length. More particularly, at the first end 9a, the screen 24 is shown to have a reduced depth into the water. Additionally, the first end 9a of the floating member 6 comprises a wind resistance member 17, such as a vane, tower, sail, or the like, for increasing the air resistance at the first and second end 9a, 9b of the floating barrier 6.

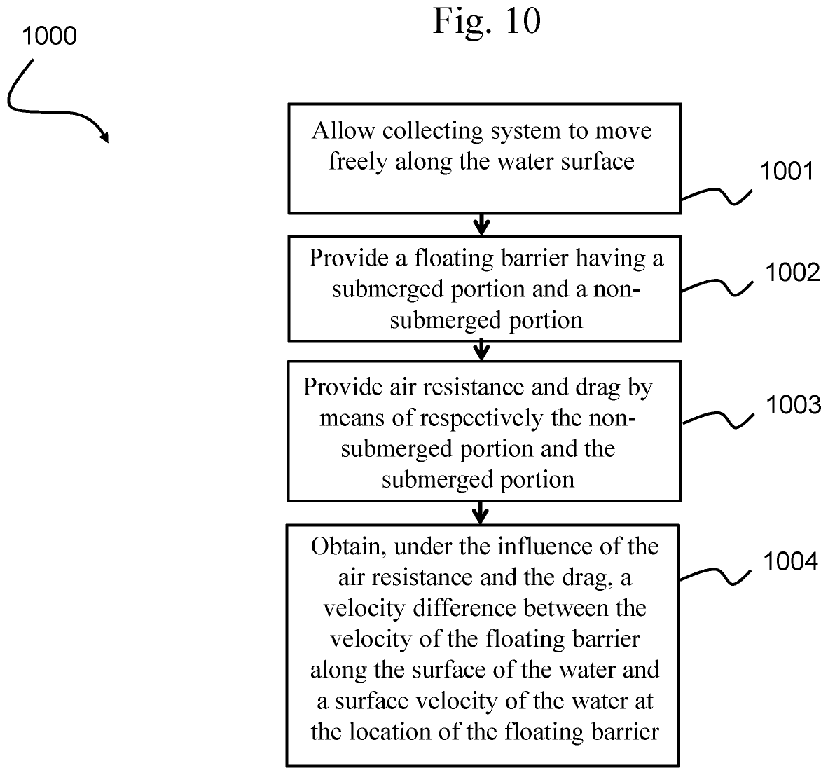

FIG. 10 shows a schematic diagram of a method for collecting objects on or near a surface of water by means of a collecting system 1 comprising a floating barrier 6. In a first step 1001, the collecting system 1 is unanchored to or on the seabed such that the collecting system 1 is free to move along the surface of the water. In a second step 1002, a floating barrier 6 having a non-submerged portion 7a and a submerged portion 7b is provided. In a third step 1003, air resistance is provided by means of at least the non-submerged member 7a when subjected to wind, and drag is provided at least by means of the submerged portion when the floating barrier is moved along the surface of the water. In a fourth step 1004, as a result of the air resistance and the drag a difference is obtained in a velocity of the floating barrier 6 along the surface of the water 4 with respect to a velocity of the objects 2 floating on or suspended near the surface of water 4 at the location of the floating barrier 6.

In an example, the air resistance and drag cause the collecting system to move faster through the water than the objects. The collecting system may move under the influence of water flow/current (drag) and wind (wind resistance) while approaching objects floating on or suspended near a surface of water for collection. Advantageously, the collecting system may be configured such that the ends are more susceptible to wind than the portion between the two ends (e.g. middle portion). The ends of the floating barrier of the collecting system may have a lower drag and/or a higher air resistance. As a result, the floating structure can (self-) orient itself towards the to be collected objects. In an example, the ends are more susceptible to wind, as a result of reduced drag encountered by the submerged-portion of the floating barrier at the ends of the floating barrier. The middle portion between the two ends may experience more drag than the ends of the floating barrier. Additionally or alternatively, a higher air resistance can be provided at the ends of the floating barrier.

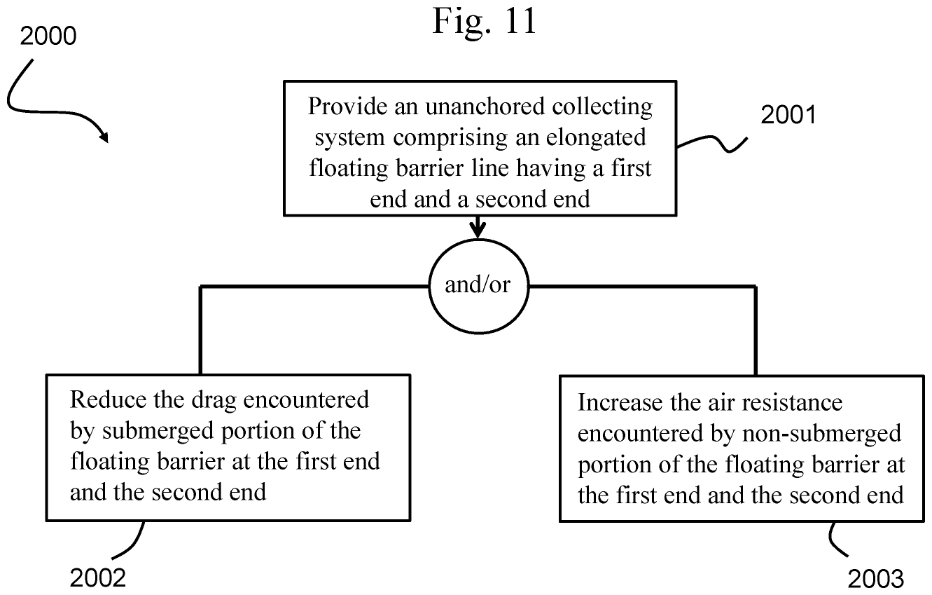

FIG. 11 shows a schematic diagram of a method for collecting objects on or near a surface of water. In a first step 2001, an unanchored collecting system 1 is provided including a floating barrier 6 forming an elongated floating barrier line having a first end 9a and a second end 9h. The method further includes at least one of the: reducing the drag encountered by the submerged-portion of the floating barrier 6 at the first and second end 9a, 9b of the floating barrier 6 relative to other parts of the floating barrier 6 (step 2002), or increasing the air resistance encountered by the non-submerged-portion of the floating barrier 6 at the first end and second end 9a, 9b of the floating barrier 6 relative to other parts of the floating barrier 6 (step 2003). This may also aid in automatically, passively steering the collecting system for collecting the objects.

It is noted that within ocean currents plastic tends to gravitate towards high concentration zones. Because substantially the same forces act on the floating barrier as on the plastic debris, they will both be pushed to the same areas. Hence, the collecting systems will automatically gravitate to where these high concentration zones are.

The collecting system 1 of the shown embodiments can function equally well in any body of liquid wherein the objects/debris 2 on the surface thereof has a lesser density than the body of liquid.

Although the examples show screens 22 with different depths, the encountered drag along the length of the floating barrier can be varied in other ways. For instance, the screens may have openings, wherein the size, shape and location of the openings can influence the encountered drag. Other ways for influencing the encountered drag by means of screens are also possible. For example, the screens can be connected to additional drag members which locally can increase the encountered drag relative to other parts (e.g. tapered portions).

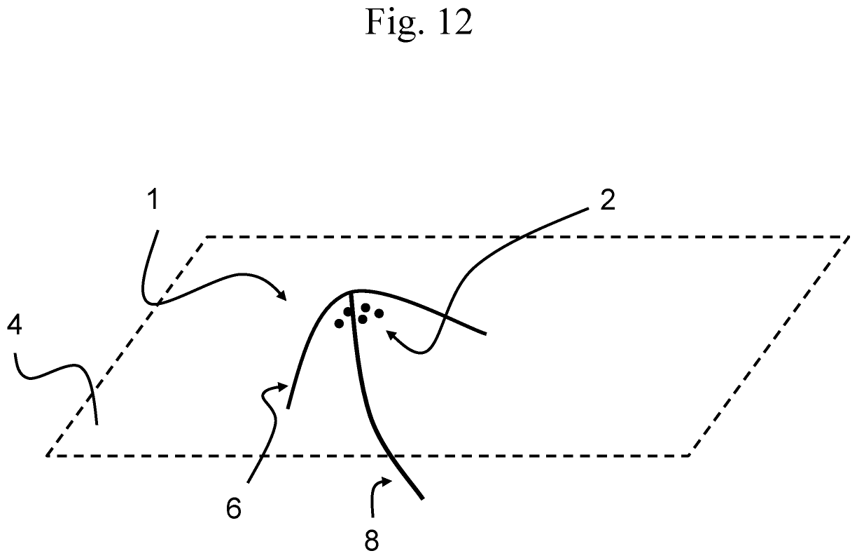

FIG. 12 shows a schematic diagram of an embodiment of a collecting system 1. The collecting system 1 is arranged for collecting objects 2 floating on or suspended near a surface 4 of water comprising a floating barrier 6 floating on the surface 4. The system further includes a submerged member 8 connected to the floating barrier 6 arranged for providing a difference between the velocity of the floating barrier 6 along the surface 4 of the water and a surface velocity of the water at the location of the floating barrier 6. The floating barrier 6 can freely move along the surface of the water 4, although the velocity of the floating member 6 may be affected by the submerged member 8. here, the submerged member comprises a line connected to the floating barrier 6. Ocean debris or objects 2 are collected by the floating barrier 6. The floating barrier 6 includes a concave portion at which a collecting region is formed where debris may collect. Hence, the floating barrier has a capture form defining a collecting region where debris can accumulate. Many shapes can be employed, such as a parabolic-shape, V-shape, U-shape. However, other more complex shapes can also be used, for example including a plurality of concave portions.

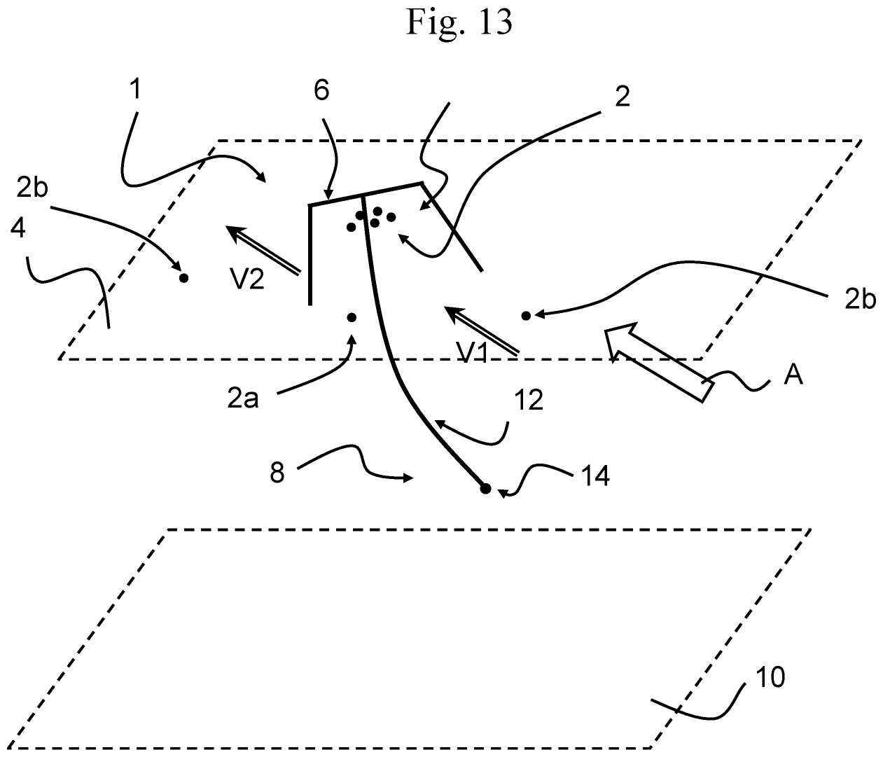

FIG. 13 shows a schematic diagram of an embodiment of a collecting system 1. The system 1 comprises a submerged member 8 connected to the floating barrier 6. The submerged member 8 is arranged for providing a difference between the velocity of the floating barrier 6 along the surface of the water and a flow velocity of the surface water at the location of the floating barrier 6. The collecting system 1 is unanchored to or on the seabed 10 such that it is free to move along the surface 4 of the water. A number of objects 2, 2a, 2b floating on or suspended near the surface 4 of water are shown. The objects 2, 2a, 2b are dispersed on the surface 4 of the water and may be collected by the floating barrier 6. The water surrounding the floating barrier 6 may have a flowing direction A at and/or near the surface 4 which may be the result of a current (e.g. ocean current resulting from a gyre). By means of the submerged member 8 connected to the floating barrier 6, a velocity V2 of the floating barrier 6 along the surface of the water 4 differs from a surface velocity V1 of the water at the location of the floating barrier 6. In other words, the velocity of the floating barrier 6 has been changed with respect to the velocity of the water at the surface 4 near or directly surrounding the floating barrier 6. As can be seen in FIG. 13, object 2a can be directed to the collecting region 16 in which objects 2 can be collected. The shape of floating barrier 6 is such that the collected objects 2 are retained within the collecting region 16. The submerged member 8 comprises a line 12 connected to the floating member 6. The submerged member 8 further includes a drag member 14 arranged for increasing the drag of the submerged member 8 when moving through water.

In the shown embodiment of FIG. 13, the floating barrier 6 has a substantially fixed form or shape (e.g. by using stiff or rigid elements). In this way, the collecting region 16 in which objects 2 can accumulate is pre-formed.

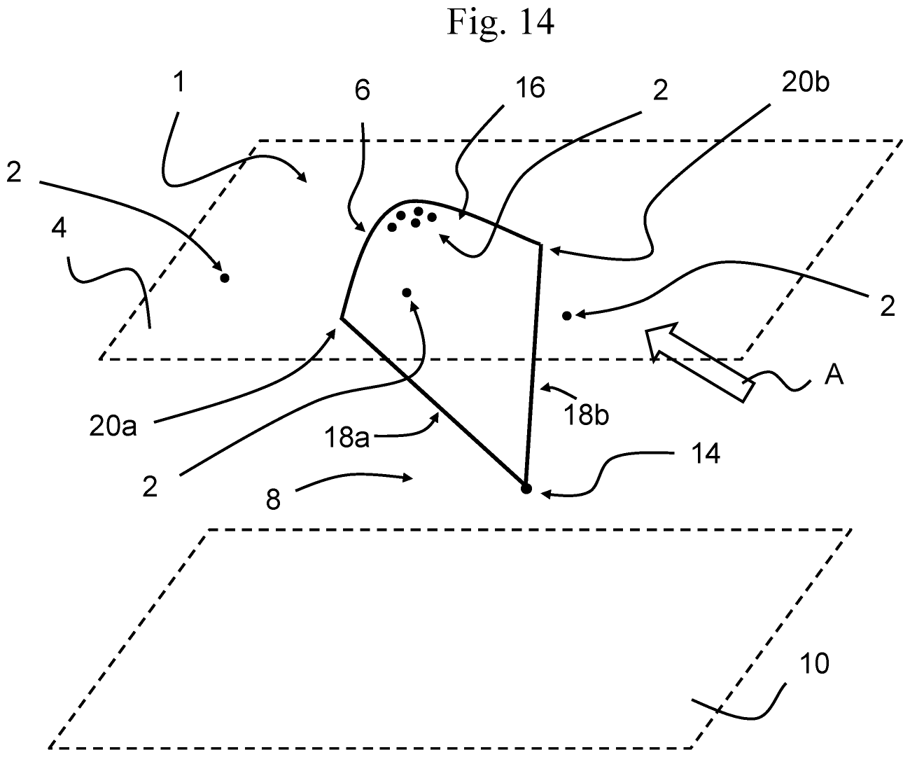

FIG. 14 shows a schematic diagram of an embodiment of a collecting system 1. The floating member 6 of the collecting system 1 is floating on a surface 4 of water having a flow direction A resulting from a water current. The water current may be an oceanic current resulting from a gyre. The collecting system 1 is not anchored and can move freely along the surface 4 of the water. In this way, the collecting system 1 can be carried along with the current. The water at the surface 4 has a certain velocity V1. Also the debris and objects 2 can move along with the water at the surface 4 in the flow direction A. The submerged member 8 is connected to the floating member 6 through a first line 18a and a second line 18b. The floating barrier 6 forms a U-shaped collecting region 16 in which debris or objects 2 accumulate.

Contrary to the embodiment of FIG. 13, here the floating barrier 6 has a flexible form such that the shape of the collecting region 16 in which objects 2 accumulate can change. The floating barrier 6 forms an elongated floating barrier line 6 having a first end 20a and a second end 20b, wherein the first end 20a and the second end 20b are connected to the submerged member 8. The first end 20a is connected to the first line 18a and the second end 20b is connected to the second line 18b. Although two lines 18a, 18b are shown, it will be appreciated that more than two lines are also possible, such as for example three, four, six or eight lines. The elongated floating barrier line 6 has a bending flexibility. As a result of the bending flexibility a collecting region 16 is formed between the first end 20a and the second end 20b. Notwithstanding the bending flexibility, the elongate floating barrier line 6 has sufficient stiffness to prevent folding of the elongate floating barrier line due to pulling forces in the first and second lines 18a, 18b. Further, the submerged member comprises a drag member 14 configured to increase the resulting drag of the submerged member 8 so that the velocity of the floating barrier 6 can be changed with respect to the surface velocity of the water and thus also the velocity of the objects 2 floating on or suspended near the surface 4 of the water moving in flow direction A, for example as a result of water currents induced by oceanic gyres. Thus the collecting system can move along with the currents.

Flexibility of the floating barrier 6 also allows the floating barrier 6 to move along with the waves so that the floating barrier can conform to the non-planar surface of the water in the event of waves. Thus also the collecting system 1 can also be able to survive extreme weather conditions.

The elongated floating barrier line 6 disposed between the first end 20a and the second end 20b results in a parabolic shape in use when the floating barrier 6 is deformed as a result of the flowing water at the surface 4, because the first end 20a and the second end 20b are connected with the submerged member 8 providing additional resistance to the movement of the elongated floating barrier line 6 moving along on the surface of the water 4 in a flow direction A. Since the first and second ends 20a, 20b are pulled in a direction different from the direction A of the flowing water at the surface 4, a collecting region 16 can be automatically formed, in which the collected objects/debris can be effectively held. This arrangement enables automatic maneuverability of the collecting system 1, wherein the floating barrier 6 being carried along with a water current automatically re-orients itself when the flowing direction A of the water current is changed, such that a concave collecting region is formed facing an upstream direction of the flow. In this way, the objects/debris can be effectively collected downstream as a result of the velocity difference obtained as a result of the additional resistance provided by the submerged member 8 connected to the first and second end 20a, 20b of the elongated floating barrier line 6. It will be appreciated that more in general it is possible that the first line 18a is attached to the floating barrier 6 at a first attachment position and the second line 18b is attached to the floating barrier 6 at a second attachment position, the first and second attachment positions being spaced apart along the floating barrier. The first attachment position may e.g. have a first offset relative to the first end 20a. The second attachment position may e.g. have a second, different or same, offset relative to the second end 20b.

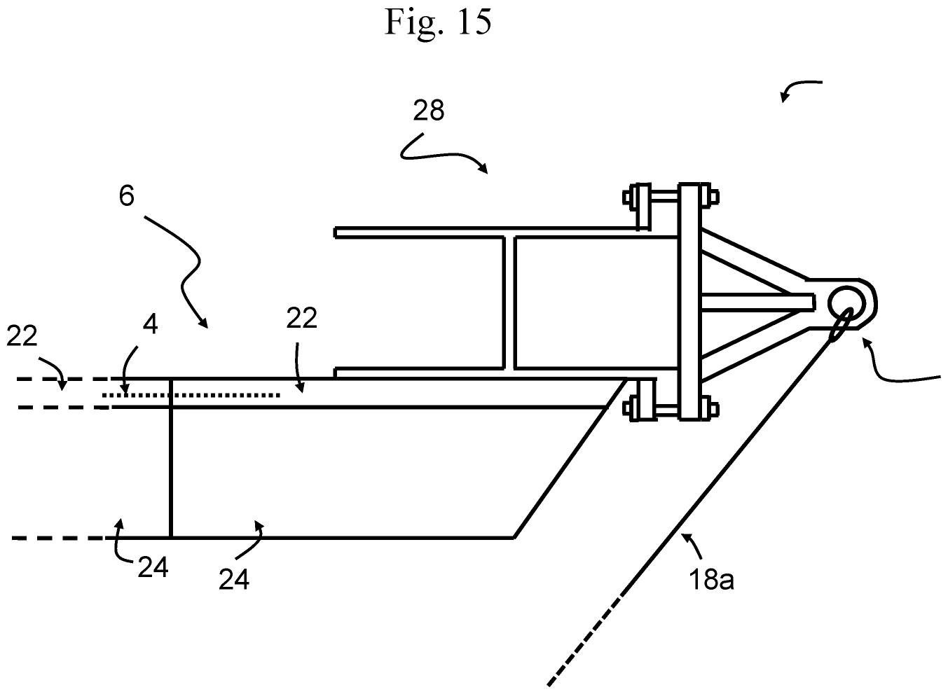

FIG. 15 shows a schematic diagram of an embodiment of a floating barrier holding portion 28 connecting the floating barrier 6 with the submerged member 8. The holding portion 28 is formed at an end 20a of an elongated floating barrier line 6 and holds a first line 18a. The first line 18a is connected to the submerged member 8. The connection portion 28 is arranged such that the orientation of the submerged member 8 with respect to the floating barrier 6 can be changed under influence of external forces, for example as a result of the flow of water, currents, wind, etc. In this way, the collecting system 1 may adapt better to the dynamic water conditions. It will be clear that a similar, or identical, second holding portion can be provided at the other end 20b, e.g. for attachment to the other line 18b.

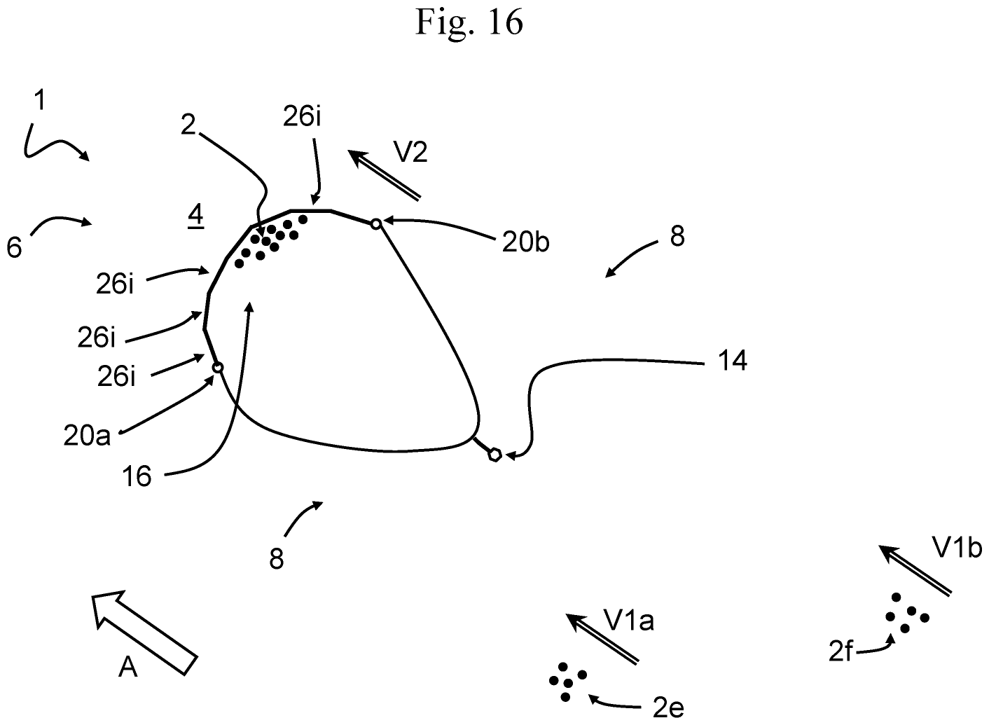

FIG. 16 shows a schematic diagram of an embodiment of a collecting system 1 comprising a floating barrier 6 with a plurality of sections 26i movably connected to each other to form an elongated floating barrier line 6. The floating barrier 6 is at a first end 20a and a second end 20b connected with a submerged member 8. The submerged member 8 includes a drag member 14 for further increasing the resulting drag. As a result, a difference between the velocity of the floating barrier 6 along the surface 4 of the water and a surface velocity of the water at the location of the floating barrier 6 is provided, allowing a more effective collection of objects by the floating member 6, since the objects 2 can be carried along with the water at a different velocity than the floating barrier 6. As a result of extra drag obtained by means of the submerged member 8, the elongated floating barrier line 6 can be slowed down (brake effect resulting from the extra drag/resistance), so that objects 2 can rather easily enter the collecting region 16 of the floating barrier 6. For instance, in the surrounding area of the elongated floating barrier line 6, objects 2e and objects 2f may be swept along with the current in a flow direction A. The velocity V1a of objects 2e and velocity V1b of objects 2f may be more or less the same. Variations are possible. However, a substantial difference between velocities V1a, V1b of the objects 2e, 2f floating on or suspended near the surface of the water, and the velocity V2 of the floating barrier 6 can be provided as a result of the additional resistance/drag obtained by the submerged member 8. Advantageously, the objects 2e, 2f may be carried along on the surface 4 of the water ending up in the collecting region 16 of the collecting system 1 when the velocity V2 of the floating barrier 6 is smaller than the velocities V1a, V1b of the objects 2e, 2f. The objects 2, 2e, 2f can further accumulate while the unanchored collecting system 1 is carried along with the water current in the flow direction A.

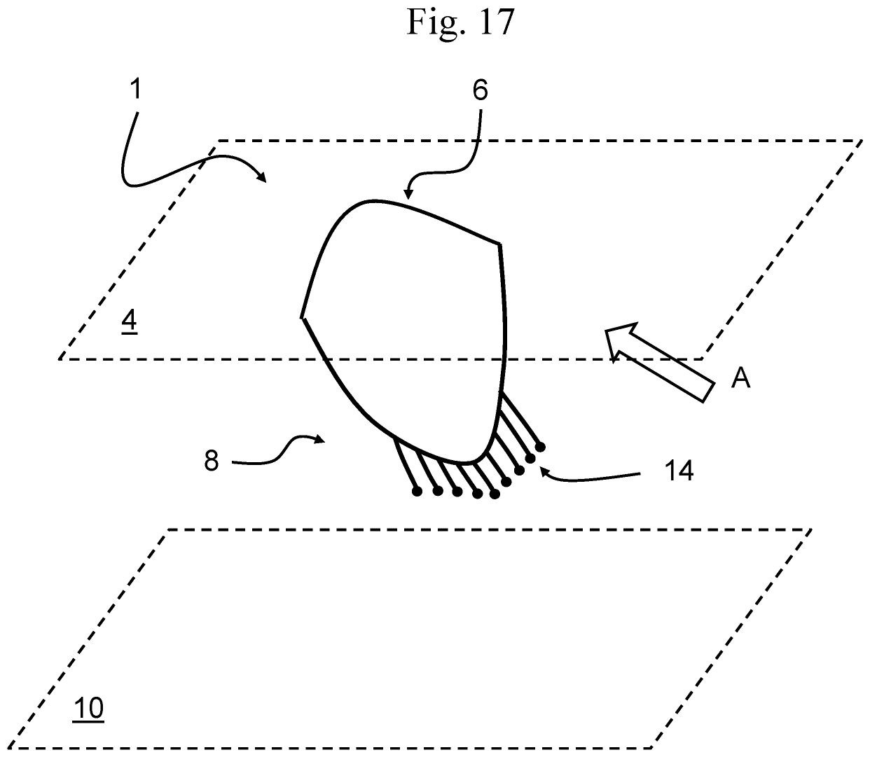

FIG. 17 shows a schematic diagram of an embodiment of a collecting system 1. The submerged member 8 comprises a plurality of drag members 14 arranged for increasing the drag of the submerged member 8. In this example, the plurality of drag member 14 are placed in parallel. The drag members 14 are attached to a line connecting the ends 20a, 20b of the floating barrier 6. The floating barrier 6 is arranged to freely move along the surface 4 of the water. For this purpose, the floating barrier is unanchored to a bottom 10 (e.g. seabed) of the water mass. As a result of the additional resistance/drag obtained by means of the submerged member 8, the floating barrier 6 can be advantageously slowed down with respect to the water at the surface at the location of the floating barrier 6.

Many types of submerged members 8 can be deployed beneath the surface 4 of the water for resisting movement through the water. Additionally, the submerged member 8 may also be beneficial for resisting movement of the floating barrier 6 as a result of wind. Most of the time, the submerged member 8 is used to slow down the speed of the floating barrier 6 moving along the surface 4 of the water. The submerged member 8 may comprise adjustment means for changing an extent to which it can provide resistance to movement through water. For this purpose, the submerged member 8 may have pull-type controls for varying the amount of drag to be obtained. In general, the resulting drag of a submerged member 8 can be changed by changing geometrical parameters of the submerged member 8. A change of the shape or geometry (e.g. angle between two parts) of a submerged member 8 or drag member 14, the drag can be influenced. For example, the submerged member 8 may comprise a parachute with a central opening, wherein the opening is adjustable. Many variants are possible.

Advantageously, also in this embodiment it is possible to better take into account dynamic ocean conditions. If the floating barrier 6 is fixed or anchored in one direction, objects 2 floating on or suspended near a surface of water (e.g. plastic garbage 2) may be lost during the collecting process. The collecting system 1 according to the current invention can more easily follow the water currents and reduce the risk of the objects escaping. Next to the braking effect, also an advantageous steering effect may be obtained by means of the submerged member 8. The submerged member 8 allows the collecting system 1 to be steered by creating a pivoting momentum which orientation enables the collecting system 1 to be perpendicular to the current. In this way, the collecting system can automatically reorient itself when for example the current changes orientation. Moreover, the loads encountered by the collecting system 1 may be reduced. Indeed, a collecting system being unfixed or unanchored at a location in the water mass (e.g. unanchored to a seabed or bottom of an ocean) may have to cope with lower static loads.

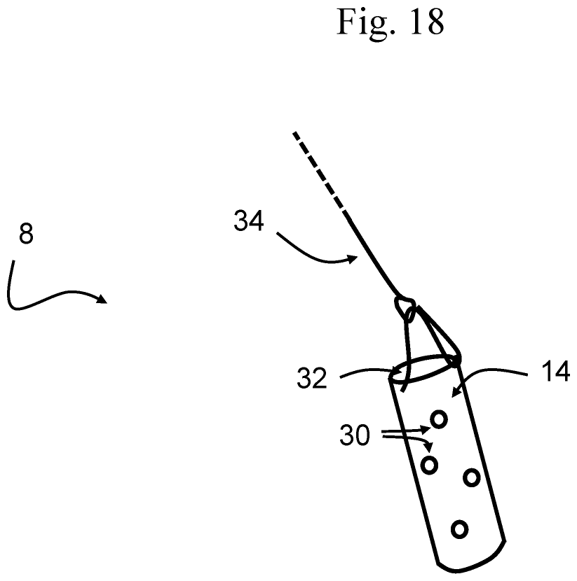

FIG. 18 shows an embodiment of a drag member 14 of a submerged member 8. The drag member 14 is formed by a hollow tube 14 comprising a plurality of holes 30 in the side wall. The tube may further have one or more open ends 32 such as to further increase the drag. The submerged member 8 can be held by a line 34 directly or indirectly connected to the floating member 6.

Other types of drag members 14 may also be employed. According to an embodiment, the submerged member includes a drift anchor, sea anchor and/or drogue. Other similar means may also be used, such as a parachute anchor, drift sock, para-anchor, parachute sea anchor or boat brake. Many variants are possible for increasing the resistance of the floating barrier 6 when being carried along water currents for obtaining a velocity difference between the floating barrier 6 and the velocity of the water at the surface.

Advantageously a drift anchor or the like may also result in an improved stabilization of the floating barrier 6 of the collecting system 1. This may be particularly advantageous in heavy weather and/or turbulent water conditions. Rather than tethering the floating barrier to the seabed, the sea anchor increases the drag through the water and thus acts as a brake. Furthermore, such a configuration also allows autonomous orientation of the floating barrier 6 carried along by the water current so that debris and/or objects can easily be collected in a collected region 16 of the collecting system 1. In this way, the floating barrier 6 can be slowed down and move in a more controlled way.

Many types of structures can be used as drag member 14 for acting as a source of drag in the water. The drag may be used to slow the floating barrier moving on the surface 4 of the water. A simple form of a drag member is just a line (e.g. anchor rode) submerged in the water. Although in some cases the resulting increase in drag may be limited, it may suffice for obtaining a velocity difference. A cloth, for instance shaped like a parachute or cone may also be employed as a drag member 14. This type of drag members 14 may require a smaller operating depth. For instance, a cloth-type drag member 14 may be configured to be submerged just under the surface. Water moving past the cloth-type drag member 14 may keep it filled. An adjustable opening may be arranged in a rear side allowing the amount of braking to be adjusted when deployed.

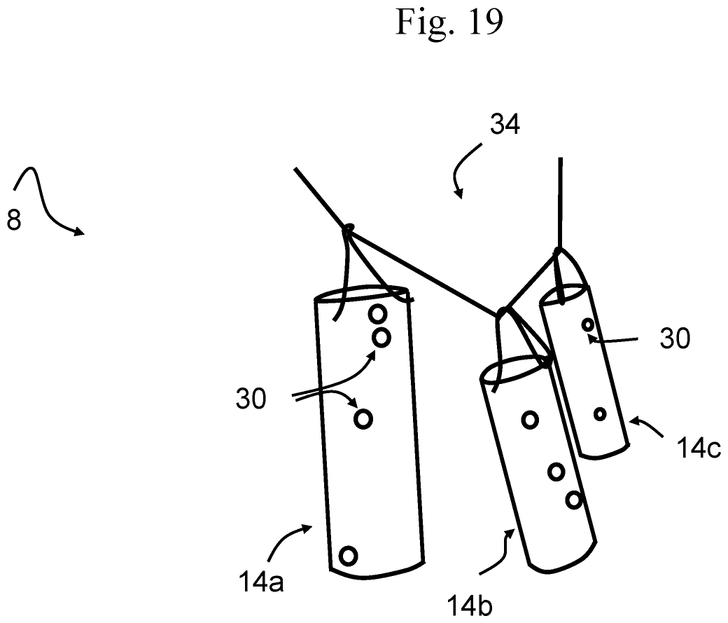

FIG. 19 shows an embodiment of a submerged member 8 comprising a plurality of drag members 14a, 14b, 14c arranged for further increasing the drag/resistance when moving through water. In accordance with the embodiment of FIG. 18, the drag members 14a, 14b, 14c comprise a plurality of holes 30 for influencing the underwater resistance to movement or drag. By increasing the drag forces, the velocity of the floating barrier carried along in a flow direction A can be effectively influenced.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

According to an aspect, the invention also relates in general terms to the following clauses:

1. A method for collecting objects floating on or suspended near a surface of water by means of a collecting system comprising a floating barrier, wherein, in use, the collecting system is unanchored to or on the seabed such that the collecting system is free to move along the surface of the water, the method including:

providing a submerged member connected to the floating barrier, such that a velocity of the floating barrier along the surface of the water differs from a velocity of the objects floating on or suspended near the surface of the water at the location of the floating barrier.

2. A method according to clause 1, wherein at least one line connected to the floating barrier is employed as the submerged member.
3. A method according to clause 1 or 2, wherein the submerged member includes one or more drag members for increasing the drag of the submerged member.
4. A method according to any one of the preceding clauses, wherein a sea anchor, drift anchor and/or drogue is employed as the submerged member.
5. A method according to any one of the preceding clauses, wherein the objects include debris, such as plastic waste.
6. A method for recycling plastic, wherein the plastic is obtained by collecting plastic objects floating on or suspended near a surface of water by means of a collecting system comprising a floating barrier, wherein, in use, the collecting system is unanchored to or on the seabed such that the collecting system is free to move along the surface of the water, the collecting including:

providing a submerged member connected to the floating barrier, such that a velocity of the floating barrier along the surface of the water differs from a velocity of the objects floating on or suspended near the surface of the water at the location of the floating barrier.

7. A method according to clause 6, further including using the collected plastic as base material for manufacturing plastic objects, such as portions of the collecting system.
8. A method for collecting objects floating on or suspended near a surface of water the method including:

providing an unanchored collecting system comprising a floating barrier, and allowing the collecting system to follow ocean currents.

9. A collecting system for collecting objects floating on or suspended near a surface of water comprising a floating barrier, arranged for freely moving along the surface of the water, wherein the system further includes a submerged member connected to the floating barrier arranged for providing a difference between the velocity of the floating barrier along the surface of the water and a velocity of the objects floating on or suspended near the surface of the water at the location of the floating barrier.
10. A collecting system according to clause 9, wherein the submerged member comprises at least one line connected to the floating barrier.
11. A collecting system according to clause 9 or 10, wherein the submerged member further includes one or more drag members arranged for increasing the drag of the submerged member.
12. A collecting system according to any one of the clauses 9-11, wherein the submerged member includes a sea anchor, drift anchor and/or drogue.
13. A collecting system according to any one of the clauses 9-12, wherein the floating barrier comprises at least one floater and a screen connected to each other, wherein the screen extends downwards in the water.
14. A collecting system according to any one of the clauses 9-13, wherein, in use, the floating barrier forms a V-shaped or U-shaped collecting region in which debris accumulates.
15. A collecting system according to any one of the clauses 9-14, wherein the floating barrier forms an elongated floating barrier line.
16. A collecting system according to clause 15, wherein the elongated floating barrier line has a first end and a second end, wherein the first end and the second end are connected to the submerged member, wherein the elongated floating barrier line has a bending flexibility such that, in use, a collecting region is formed between the first end and the second end.
17. A collecting system according to clause 15 or 16, wherein the elongated floating barrier line comprises a plurality of sections connected to each other.
18. A collecting system according to any one of the clauses 9-17, further comprising a buffer unit including a space for storing objects, such as debris.
19. Plastic obtained by employing the method according to any one of the method clauses 1-8.

1. A method for collecting objects floating on or suspended near a surface of water by means of a collecting system comprising a floating barrier, wherein, in use, the collecting system is unanchored to or on the seabed such that the collecting system is free to move along the surface of the water, the method including:
providing the floating barrier having a non-submerged portion and a submerged portion, wherein at least the non-submerged portion provides air resistance when subjected to wind, and at least the submerged portion provides drag when the floating barrier is moved along the surface of the water, wherein as a result of the air resistance and the drag a difference is obtained in a velocity of the floating barrier along the surface of the water with respect to a velocity of the objects floating on or suspended near the surface of water at the location of the floating barrier.

2. The method according to claim 1, wherein the air resistance and drag cause the collecting system to move slower through the water than the objects.

3. The method according to claim 1, wherein the ratio of air resistance and drag for the floating barrier is smaller than the ratio of air resistance and drag of the objects to be collected.

4. (canceled)

5. The method according to claim 1, wherein the objects include debris, such as plastic waste.

6. (canceled)

7. The method according to claim 1, wherein at least one connection line is provided configured for connecting two parts of the elongated floating barrier so as to maintain a curved floating barrier.

8. The method according to claim 1, wherein the floating barrier comprises at least one floater and a screen connected thereto, wherein the screen extends downwards in the water and provides drag when the floating barrier is moved along the surface of the water, and wherein at least a non-submerged portion of the floater of the floating barrier provides air resistance.

9. (canceled)

10. (canceled)

11. The method according to claim 1, including collecting plastic objects floating on or suspended near a surface of water and recycling the plastic.

12. (canceled)

13. (canceled)

14. A collecting system for collecting objects floating on or suspended near a surface of water comprising a floating barrier, arranged for freely moving along the surface of the water, wherein the floating barrier comprises a non-submerged portion and a submerged portion, wherein the non-submerged portion is configured to provide air resistance when subjected to wind, and the submerged portion is configured to provide drag when the floating barrier moves along the surface of the water, wherein as a result of the air resistance and the drag a difference is obtained in a velocity of the floating barrier along the surface of the water with respect to a velocity of the objects floating on or suspended near the surface of water at the location of the floating barrier.

15. The collecting system according to claim 14, wherein the air resistance and drag cause the collecting system to move slower through the water than the objects.

16. The method according to claim 14, wherein the ratio of air resistance and drag for the floating barrier is smaller than the ratio of air resistance and drag of the objects to be collected.

17. (canceled)

18. (canceled)

19. The collecting system according to claim 14, wherein the floating barrier comprises at least one floater and a screen connected to each other, wherein the screen extends downwards in the water.

20. (canceled)

21. The collecting system according to claim 14, wherein the floating barrier forms an elongated floating barrier line.

22. (canceled)

23. The collecting system according to claim 14, further comprising a buffer unit including a space for storing collected objects, such as debris.

24. The collecting system according to claim 14, wherein at least one connection line is provided configured for connecting two parts of the elongated floating barrier so as to maintain a curved floating barrier.

25. The collecting system according to claim 14, wherein the floating barrier comprises at least one floater and a downwardly extending screen connected thereto, wherein at least the screen is configured to provide drag when the floating barrier is moved along the surface of the water, and wherein at least a non-submerged portion of the floater of the floating barrier is configured to provide air resistance.

26. The collecting system according to claim 25, wherein the depth of the screen adjacent the first and second end is reduced towards the first and second end of the floating barrier.

27. (canceled)

28. Plastic obtained by employing the method according to claim 11.

29. The method according to claim 1, wherein the submerged portion includes a submerged member connected to the floating barrier at a first attachment portion and at a second attachment portion, the first and second attachment portions being spaced apart along the floating barrier, so that the floating barrier automatically re-orients itself when the direction of water current, waves and/or wind changes, such that a concave collecting region is formed facing an upstream direction of the flow.

30. The method according to claim 1, wherein the submerged member includes for increasing the drag of the submerged member one or more drag members, such as one or more sea anchors, drift anchors, drogues, parachute anchors, drift socks, para-anchors, parachute sea anchors and/or boat brakes.

31. The collecting system according to claim 14, wherein the submerged portion includes a submerged member connected to the floating barrier at a first attachment portion and at a second attachment portion, the first and second attachment portions being spaced apart along the floating barrier, such that the floating barrier automatically re-orients itself when the direction of water current, waves and/or wind changes, such that a concave collecting region is formed facing an upstream direction of the flow.
